(19) United States
(12) Patent Application Publication
(10) Pub. No.: US 2026/0275623 A1
(43) Pub. Date: Sep. 17, 2026

(54) CLOTHING TREATING DEVICE AND METHOD FOR CONTROLLING CLOTHING TREATING DEVICE

(71) Applicant: LG ELECTRONICS INC., Seoul (KR)

(72) Inventors: Taewon CHEON, Seoul (KR); Joseph LEE, Seoul (KR); Byeongjo RYOO, Seoul (KR)

(73) Assignee: LG ELECTRONICS INC., Seoul (KR)

(21) Appl. No.: 19/469,686

(22) PCT Filed: Apr. 4, 2024
(86) PCT No.: PCT/KR2024/004395

§ 371 Date: Sep. 26, 2025

(30) Foreign Application Priority Data
Apr. 4, 2023 (KR) 10-2023-0044239

(51) Int. Cl. D06F 58/45; D06F 58/24; D06F 105/02

(52) U.S. Cl. CPC D06F 58/45; D06F 58/24; D06F 2105/02

(57) ABSTRACT

A clothing treating device of the present disclosure relates to a clothing treating device in which a circulation duct or a heat exchanger is washed using at least one of condensed water and direct water which is supplied from an external water source, and to a control method therefor. The clothing treating device of the present disclosure comprises: a circulation duct provided to guide air discharged from a drum into the drum; a heat exchanger disposed inside the circulation duct to cool the air to condense moisture and to heat the air; a circulation washing unit that washes the heat exchanger with water collected in the water collection unit; and a direct water washing unit that is provided independently of the circulation washing unit and receives water from an external water source and supplies the water into the circulation duct to wash the inside of the circulation duct.

### TECHNICAL FIELD

The present disclosure relates to a laundry treating apparatus that dries laundry and has a self-cleaning function.

### BACKGROUND

A laundry treating apparatus, such as a dryer, is designed to circulate air within a drum where laundry is accommodated through a circulation duct. Air is first cooled to condense moisture and then reheated to generate hot air, which is fed back into the drum. By circulating air inside the drum as such, moisture contained in the laundry may be continuously dried.

Such a dryer has an advantage of preventing or minimizing an inflow of external air or an outflow of air inside the drum, allowing a large quantity of laundry to be dried consecutively without changing humidity or temperature of an environment outside the dryer.

However, as the laundry is dried, not only moisture evaporates, but foreign substances such as lint and fluff are also separated from the laundry by hot air. Such separated foreign substances may circulate continuously through the drum and the circulation duct and be reattached to the laundry or adhered to a heat exchanger that cools or heats air or the like.

Over time, such adhered foreign substances may grow in size, obstructing a flow of air circulating in the circulation duct and, because of a high-temperature and high-humidity environment, may foster bacterial growth and decomposition.

Therefore, the existing dryer has an inconvenience that a user or maintenance personnel should regularly remove the foreign substances accumulated in the heat exchanger or the circulation duct.

Recently, a dryer that may automatically remove such foreign substances using water has emerged (See Korean Patent No. 10-1806241).

Such a dryer is equipped with a circulation cleaning part that discharges water, which has been condensed and collected in the heat exchanger, back into the heat exchanger to clean the same. When a drying cycle is performed and moisture is evaporated from the laundry, the dryer may condense and collect th evaporated moisture and may automatically clean the heat exchanger intermittently until or after the drying cycle ends. As a result, such a dryer offers convenience by eliminating a need to manually remove the foreign substances attached to the heat exchanger.

However, because such a dryer cleans the heat exchanger using water discharged from the laundry, water likely contains the foreign substances removed from the laundry, which leads to recontamination of the heat exchanger by the foreign substances remaining in water.

Additionally, when an amount of moisture evaporated from the laundry is small and thus an amount of collected water is small, such a dryer has a fundamental limitation of not being able to clean the heat exchanger.

To solve such problems, a laundry treating apparatus capable of supplying water to the circulation cleaning part has emerged (see Korean Patent Application Publication No. 10-2021-0114092).

The laundry treating apparatus has an advantage of supplying clean water directly from an external water source to the circulation cleaning part, enabling the heat exchanger cleaning even when water is insufficient in the circulation cleaning part.

However, because water from the external water source is supplied to the heat exchanger or the like via the circulation cleaning part that circulates condensate, there remains a possibility that the foreign substances may contaminate the heat exchanger again. Moreover, the laundry treating apparatus has a possibility that a flow channel supplying water from the external source itself may be exposed to the foreign substances and be blocked or contaminated.

The laundry treating apparatus has also disclosed a technology of supplying only water to the heat exchanger as a separate embodiment. However, this embodiment also has a problem that when the external water source has a low water pressure, it is difficult for water to reach the heat exchanger, making the water cleaning impossible.

Furthermore, the above embodiment has a problem that supplied water is not able to be reused, for example, in cleaning a heat exchanger part or the circulation cleaning part again.

Additionally, in the dryer, there is a possibility that a water pipe that supplies water or the like may come into contact with the rotating drum and be damaged or interfere with the drum rotation.

All existing dryers also fundamentally lack a capability to clean the foreign substances accumulated inside a duct, apart from the heat exchanger.

### SUMMARY

### Technical Problem

The present disclosure is intended to provide a laundry treating apparatus capable of cleaning a heat exchanger or a circulation duct with water supplied from an external water source.

The present disclosure is intended to provide a laundry treating apparatus capable of cleaning a heat exchanger or a circulation duct with water supplied from an external water source even when the external water source is at a low water pressure.

The present disclosure is intended to provide a laundry treating apparatus capable of cleaning a heat exchanger or a circulation duct while repeatedly circulating water supplied from an external water source.

The present disclosure is intended to provide a laundry treating apparatus capable of preventing a water cleaning part from interfering with or coming into contact with a rotating drum.

The present disclosure is intended to provide an optimal method for using a circulation cleaning part that cleans a heat exchanger and a circulation duct by circulating condensate and a water cleaning part that cleans the heat exchanger and the circulation duct by supplying water.

### Technical Solutions

To solve the above-mentioned problems, the present disclosure provides a laundry treating apparatus including a water collector that is in communication with a circulation duct and collects water condensed in a heat exchanger part therein, a circulation cleaning part that cleans the heat exchanger part by supplying water collected in the water collector into the circulation duct, and a water cleaning part that is equipped independently of the circulation cleaning part and receives water from an external water source and supplies water to the inside of the circulation duct to clean the inside of the circulation duct.

The water cleaning part may discharge water to an area of the circulation duct disposed upstream of or in front of the heat exchanger part.

The circulation duct may include an inflow duct that receives air from the front portion of the drum, a movement duct extending from the inflow duct rearward to be closer to a rear portion of the drum and having the heat exchanger part disposed therein, and an outflow duct that discharges air from the movement duct to the rear portion of the drum.

The circulation cleaning part may discharge water into the movement duct, and the water cleaning part may discharge the water to the inflow duct.

The water cleaning part may include a water valve that is coupled to a rear surface of the cabinet and receives water from the external water source, a water pipe extending from the water valve to the circulation duct, and a duct nozzle that is coupled to the circulation duct and discharges water supplied from the water pipe into the circulation duct.

The circulation cleaning part may include a drainage pump that is mounted in the water collector and discharges water from the water collector, a drain flow channel that is disposed upward of the movement duct and guides water discharged from the drainage pump to a front portion of the heat exchanger part, a drain pipe connecting the drainage pump with the drain flow channel, and a circulation water outlet that extends through the movement duct at a distal end of the drain flow channel and guides water to the heat exchanger part.

The water pipe may be disposed to be spaced apart and separated from all of the drainage pump, the drain flow channel, and the drain pipe.

The drain flow channel and the drain pipe may be shorter than the water pipe.

The water valve may be first opened and then the drainage pump may be operated.

The water valve may be first opened and then the drainage pump may be operated after the water collector is filled to a full water level.

The laundry treating apparatus may further include a water storage tank that separately stores water of the water collector therein, and the circulation cleaning part may further include a switching valve that is coupled to the movement duct and determines to discharge water in the water collector to one of the water storage tank and the drain flow channel.

The switching valve may be controlled to guide water collected in the water collector to the water storage tank when the water valve is first opened and then the water collector is filled to the full water level, and guide water collected in the water collector to the drain flow channel when the water valve is opened again and the water collector is filled to the full water level again.

The water cleaning part may discharge water to an area of the circulation duct disposed upstream of the heat exchanger part or in front of the heat exchanger.

The circulation duct may include an inflow duct that receives air from the front portion of the drum and is disposed upward of the heat exchanger, a movement duct extending from the inflow duct rearward to be closer to a rear portion of the drum and having the heat exchanger disposed therein, and an outflow duct that discharges air from the movement duct to the rear portion of the drum, and the water cleaning part may discharge water into the inflow duct.

The laundry treating apparatus may further include a filter that is detachably disposed in the inflow duct and filters air introduced into the inflow duct, and the water cleaning part may supply water to an area located upward of a lower end of the filter.

The water cleaning part may include a water valve that is coupled to a rear surface of the cabinet and receives water from the external water source, a water pipe extending from the water valve to the inflow duct, and a duct nozzle that is coupled to the inflow duct and discharges water supplied from the water pipe into the inflow duct.

The duct nozzle may include a guide pipe that is coupled to the inflow duct and guides water supplied from the water pipe into the inflow duct, a guide duct in communication with the guide pipe and extending along at least a portion of an inner surface of the inflow duct to guide water, and a duct water outlet that extends through the guide duct and sprays water into the inflow duct.

The duct water outlet may obliquely discharge water toward the inner surface of the inflow duct.

The duct water outlet may allow water to fall from the inner surface of the inflow duct toward the movement duct.

The duct water outlet may include a first water outlet extending through a lower portion of the guide duct along at least the portion of the inner surface of the inflow duct, and a second water outlet extending through the lower portion of the guide duct at a location inward of the first water outlet within the inflow duct.

The first water outlet may discharge water toward the inner surface of the inflow duct, and the second water outlet may discharge water toward the movement duct.

The laundry treating apparatus may further include a filter that is detachably disposed in the inflow duct and filters air introduced into the inflow duct, and the guide duct may accommodate the filter therein.

The guide duct may be constructed such that the inside thereof is prevented from being exposed except for the duct water outlet so as to temporarily store water introduced from the guide pipe therein.

A total cross-sectional area of the duct water outlet may be set to be smaller than a cross-sectional area of the guide pipe.

The water valve may be disposed at a location lower than the drum and higher than the heat exchanger part.

The water pipe may extend to one side of the circulation duct.

### Advantageous Effects

The present disclosure may clean the heat exchanger or the circulation duct with water supplied from the external water source.

The present disclosure may clean the heat exchanger or the circulation duct with water supplied from the external water source even when the external water source is at the low water pressure.

The present disclosure may clean the heat exchanger or the circulation duct by repeatedly circulating water supplied from the external water source.

The present disclosure prevents the water cleaning part from interfering with or coming into contact with the rotating drum.

The present disclosure provides the optimal method for using the circulation cleaning part that cleans the heat exchanger and the circulation duct by circulating condensate and the water cleaning part that cleans the heat exchanger and the circulation duct by supplying water.

### BRIEF DESCRIPTION OF THE DRAWINGS

FIG. 1 illustrates an outer appearance of a laundry treating apparatus of the present disclosure.

FIG. 2 illustrates an internal structure of a laundry treating apparatus of the present disclosure.

FIG. 3 illustrates an exploded perspective view of internal components of a laundry treating apparatus of the present disclosure.

FIG. 4 illustrates an outer appearance of a decelerator of a laundry treating apparatus of the present disclosure.

FIG. 5 illustrates an internal structure of a decelerator of a laundry treating apparatus of the present disclosure.

FIG. 6 illustrates an air circulation structure of a laundry treating apparatus of the present disclosure.

FIG. 7 illustrates a configuration of a driver of a laundry treating apparatus of the present disclosure.

FIG. 8 illustrates an arrangement structure of a motor and a decelerator of a laundry treating apparatus of the present disclosure.

FIG. 9 illustrates a coupling arrangement structure of a motor and a decelerator of a laundry treating apparatus of the present disclosure.

FIG. 10 illustrates a structure of a circulation cleaning part of a laundry treating apparatus of the present disclosure.

FIG. 11 illustrates a base internal configuration of a laundry treating apparatus of the present disclosure.

FIG. 12 illustrates a shielding duct cover structure of a laundry treating apparatus of the present disclosure.

FIG. 13 illustrates a flow channel through which water is supplied from a circulation cleaning part of a laundry treating apparatus of the present disclosure.

FIG. 14 illustrates a front portion or an upstream area of the circulation duct of the present disclosure.

FIG. 15 illustrates a water cleaning part of a laundry treating apparatus of the present disclosure.

FIG. 16 illustrates a location at which a water cleaning part may be disposed.

FIG. 17 illustrates a structure of the water cleaning part.

FIG. 18 illustrates a detailed structure of the duct nozzle.

FIG. 19 illustrates a structure of a duct water outlet.

FIG. 20 illustrates a locational relationship between a filter and a water cleaning part.

FIG. 21 illustrates a derived effect of a duct nozzle.

FIG. 22 illustrates a method for controlling a laundry treating apparatus of the present disclosure.

FIG. 23 illustrates an embodiment of a control method using a circulation cleaning part and a water cleaning part in a laundry treating apparatus of the present disclosure.

FIG. 24 illustrates an embodiment in which a laundry treating apparatus of the present disclosure performs the sensing step using a water cleaning part and a circulation cleaning part.

FIG. 25 illustrates a method of performing a water cleaning step when a water pressure of an external water source is in a normal state or a high state.

FIG. 26 illustrates a method of performing a water cleaning step when a water pressure of an external water source is in a low state.

FIG. 27 illustrates a method for controlling a laundry treating apparatus of the present disclosure when water supply is unavailable.

### BEST MODE

Hereinafter, with reference to the attached drawings, an embodiment of the present disclosure will be described in detail so as to be easily practiced by a person with ordinary skill in the art to which the present disclosure belongs.

However, the present disclosure may be implemented in various different forms and may not be limited to the embodiment described herein. In addition, to clearly illustrate the present disclosure in the drawings, parts that are not related to the description are omitted, and similar parts are given similar reference numerals throughout the present document.

In the present document, redundant descriptions of the same components are omitted.

Further, in the present document, it will be understood that when an element is referred to as being “connected with” another element, the element may be directly connected with the other element or intervening elements may also be present. In contrast, in the present document, it will be understood that when an element is referred to as being “directly connected with” another element, there are no intervening elements present.

Further, terms used herein are only used to describe a specific embodiment, and are not used as a limitation of the present disclosure.

Further, in the present document, a singular representation may include a plural representation unless it represents a definitely different meaning from the context.

Further, the terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Further, in the present document, the term ‘and/or’ includes a combination of a plurality of listed items or any of the plurality of listed items. Herein, ‘A or B’ may include ‘A’, ‘B’, or ‘both A and B’.

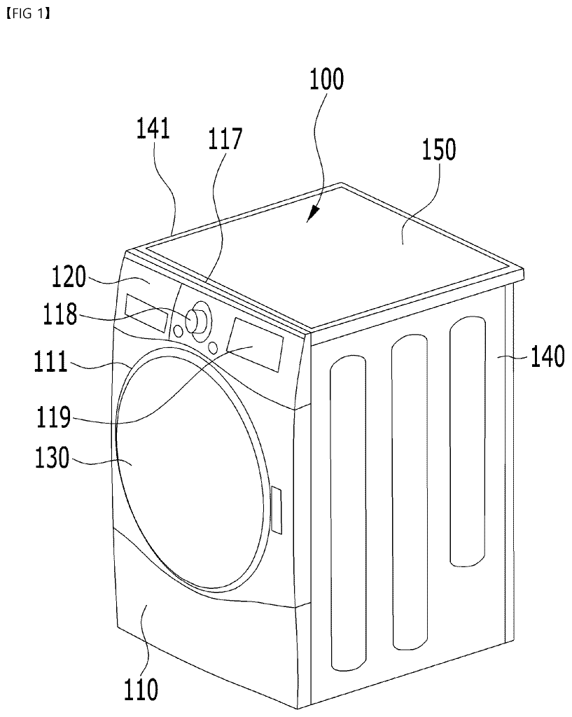

FIG. 1 illustrates an outer appearance of a laundry treating apparatus of the present disclosure.

The laundry treating apparatus according to an embodiment of the present disclosure may include a cabinet 100 forming the outer appearance thereof.

The cabinet 100 may include a front panel 110 forming a front surface of the laundry treating apparatus, a top panel 150 forming a top surface, and side panels 140 forming side surfaces. The side panels 140 may include a left panel 141 forming a left surface. The front panel 110 may include a laundry inlet 111 defined to be in communication with inside of the cabinet 100 and a door 130 pivotably coupled to the cabinet 100 to open and close the laundry inlet 111.

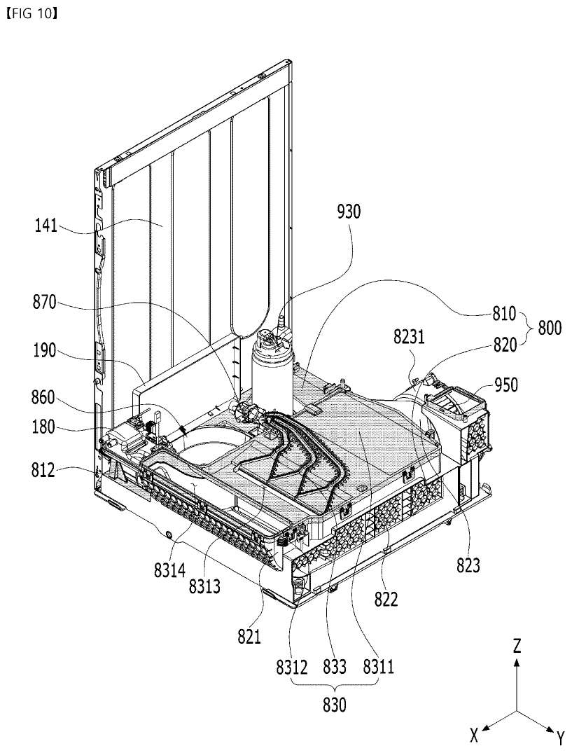

A manipulation panel 117 may be installed on the front panel 110. The manipulation panel 117 may include an input unit 118 that receives a control command from a user, and an indicator 119 that outputs information such as the control command selectable by the user. The control command may include a drying course or a drying option capable of performing a series of drying cycles. A control box (see FIG. 10) that controls internal components to execute the control command input via the input unit 118 may be installed inside the cabinet 100. The control box may be connected to the internal components of the laundry treating apparatus and control the corresponding components to execute the input command.

The input unit 118 may include a power supply request unit that requests power supply of the laundry treating apparatus, a course input unit that allows the user to select a desired course among multiple courses, and an execution request unit that requests initiation of the course selected by the user.

The indicator 119 may include at least one of a display panel capable of outputting text and figures and a speaker capable of outputting voice signals and sounds.

In one example, the laundry treating apparatus of the present disclosure may include a water storage tank 120 that separately stores moisture generated in a process of drying the laundry. The water storage tank 120 may include a handle that is withdrawable to the outside from one side of the front panel 110. The water storage tank 120 may collect condensate generated during the drying cycle. Accordingly, the user may remove the condensate by extending the water storage tank 120 from the cabinet 100, and then mount the same in the cabinet 100 again. Accordingly, the laundry treating apparatus of the present disclosure may be disposed even in a place where a drain hole or the like is not installed.

In one example, the water storage tank 120 may be disposed above the door 130. Accordingly, when extending the water storage tank 120 from the front panel 110, the user may bend a waist thereof relatively less, thereby increasing user convenience.

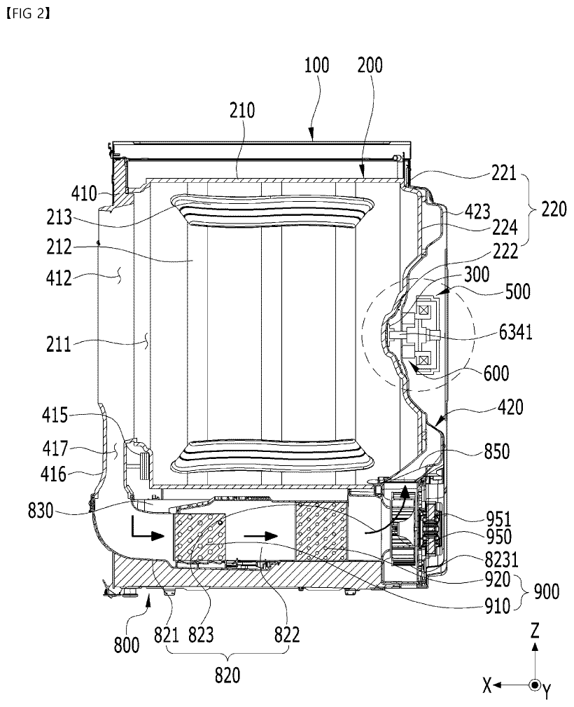

FIG. 2 schematically illustrates inside of a laundry treating apparatus of the present disclosure. The laundry treating apparatus of the present disclosure may include a drum 200 accommodated in the cabinet 100 to accommodate laundry therein, a driver that rotates the drum 200, a heat exchanger part 900 that supplies hot air to the drum 200, and a base 800 including a circulation duct 820. The circulation duct 820 is in communication with the drum 200. Air discharged from the drum 200 may be supplied to the circulation duct 820. In addition, air discharged from the circulation duct 820 may be again supplied to the drum 200.

The driver may include a motor 500 that provides power to rotate the drum 200. The driver may be directly connected to the drum 200 to rotate the drum 200. For example, the driver may be of a direct drive unit (DD) type. Accordingly, the driver may directly rotate the drum 200 by omitting components such as a belt, a pulley, and the like, thereby controlling a rotation direction of the drum 200 or a rotation speed of the drum 200.

The motor 500 may rotate at a high RPM. For example, the motor 500 may rotate at an RPM much higher than an RPM capable of rotating the drum 200 while the laundry inside the drum 200 is attached to an inner wall of the drum 200.

However, when the laundry inside the drum 200 rotates while being continuously attached to the inner wall of the drum 200, a portion thereof attached to the inner wall of the drum is not exposed to hot air, and thus a drying efficiency is reduced.

When a rotor 520 is rotated at a low RPM such that the laundry is not attached to the inner wall of the drum 200, but rolls or agitates inside the drum 200, there may be a problem in that an output or a torque that may be generated by the driver may not be properly utilized.

Accordingly, the driver of the laundry treating apparatus of the present disclosure may further include a decelerator 600 capable of increasing the torque while utilizing a maximum output of the motor 500 by reducing the RPM.

In addition, the driver may include a drum rotation shaft 6341 that is connected to the drum 200 and rotates the drum 200.

The drum 200 may be formed in a cylindrical shape to accommodate the laundry therein. In addition, unlike a drum used for washing, water does not need to be introduced into the drum 200 used only for the drying, and water in a liquid state condensed in the drum 200 does not need to be discharged to the outside of the drum 200. Therefore, through-holes defined along a circumferential surface may be omitted in the drum 200. That is, the drum 200 used only for the drying may be formed differently from the drum 200 used for the washing.

The drum 200 may be formed in an integral cylindrical shape, but may be manufactured in a form in which the drum body 210 including the circumferential surface and a drum rear surface 220 forming a rear surface are coupled to each other.

A drum inlet 211 through which the laundry enters and exits may be defined in a front portion of the drum body 210. The driver that rotates the drum may be connected to a rear portion of the drum rear surface 220. The drum body 210 and the drum rear surface 220 may be coupled to each other by a fastening member such as a bolt, but may not be limited thereto, and may be coupled to each other using various methods as long as they are coupled to each other so as to rotate together.

The drum body 210 may include a lift 213 that pulls the laundry items inside upward so as to be mixed together based on the rotation. When the drum 200 rotates, the laundry accommodated therein may repeat a process of ascending and descending by the lift 213. The laundry accommodated in the drum 200 may be evenly in contact with hot air while repeating the ascending and the descending. Therefore, the drying efficiency is increased and a drying time is shortened.

A reinforcing bead 212 may be formed on the circumferential surface of the drum body 210. The reinforcing bead 212 may be formed to be recessed or protrude inward/outward along the circumferential surface of the drum 200. Such a reinforcing bead may include a plurality of reinforcing beads, and the plurality of reinforcing beads may be spaced apart from each other. The reinforcing beads may be formed to be recessed or protrude inward/outward along the circumferential surface while forming a certain pattern.

Rigidity of the drum body 210 may be increased by the reinforcing beads 212. Accordingly, even when a large amount of laundry is accommodated in the drum body 210 or a sudden rotational force is received via the driver, the drum body 210 may be prevented from being twisted. In addition, when the reinforcing beads 212 are formed, because a gap between the laundry and an inner circumferential surface may be increased compared to a case in which the circumferential surface of the drum body 210 is formed as a flat surface, hot air supplied to the drum 200 may be more effectively introduced into a space between the laundry and the drum 200. Durability of the drum is increased and the drying efficiency of the laundry treating apparatus is increased by the reinforcing beads.

In general, in a case of a DD-type washing machine, the driver may be coupled to and fixed to a tub accommodating the drum 200 therein, and the drum 200 may be coupled to the driver to be supported by the tub. However, because the laundry treating apparatus of the present disclosure is designed to intensively perform the drying cycle, the tub fixed to the cabinet 100 to accommodate the drum 200 therein is omitted.

Accordingly, the laundry treating apparatus of the present disclosure may further include a support 400 that fixes or supports the drum 200 or the driver inside the cabinet 100.

The support 400 may include a front plate 410 disposed in front of the drum 200 and a rear plate 420 disposed at the rear of the drum 200. The front plate 410 and the rear plate 420 may be formed in a plate shape to face front and rear portions of the drum 200. A gap between the front plate 410 and the rear plate 420 may be equal to a length of the drum 200 or may be set to be greater than the length of the drum 200. The front plate 410 and the rear plate 420 may be fixed to and supported by a bottom surface of the cabinet 100 or a base 800.

The front plate 410 may be disposed between the front panel forming the front surface of the cabinet and the drum 200. In addition, the front plate 410 may include a drum inlet communication hole 412 in communication with the drum inlet 211. Because the drum inlet communication hole 412 is defined in the front plate 410, the laundry may be introduced into or withdrawn from the drum 200 while the front surface of the drum 200 is supported.

The front plate 410 may include a duct connection portion 416 disposed under the drum inlet communication hole 412. The duct connection portion 416 may form a lower portion of the front plate 410.

The front plate 410 may include a duct communication hole 417 extending through the duct connection portion 416. The duct communication hole 417 may be defined in a hollow shape to guide air discharged via the drum inlet 211 of the drum to a space under the drum 200. In addition, air discharged via the drum 211 may be guided to the circulation duct 820 located under the drum 200.

A filter (not shown) may be installed in the duct communication hole 417 to filter lint or foreign substances having large particles from the laundry. The filter may filter air discharged from the drum 200 to prevent the foreign substances from accumulating inside the laundry treating apparatus, and may prevent the foreign substances from accumulating and interfering with the circulation of air.

Because the drum inlet 211 is defined at a front side, it is preferable that the driver is installed on the rear plate 420 rather than on the front plate 410. The driver may be mounted on and supported by the rear plate 420. Accordingly, the driver may rotate the drum 200 in a state in which a location thereof is stably fixed via the rear plate 420.

At least one of the front plate 410 and the rear plate 420 may rotatably support the drum 200. At least one of the front plate 410 and the rear plate 420 may rotatably accommodate a front end or a rear end of the drum 200 therein.

For example, the front portion of the drum 200 may be rotatably supported by the front plate 410, and the rear portion of the drum 200 may be spaced apart from the rear plate 420, but may be connected to the motor 500 mounted on the rear plate 420 and be indirectly supported by the rear plate 420. Accordingly, an area in which the drum 200 is in contact with or rubs against the support 400 may be minimized, and unnecessary noise or vibration may be prevented from occurring.

In one example, the drum 200 may be rotatably supported by both the front plate 410 and the rear plate 420.

One or more support wheels 415 that support the front portion of the drum 200 may be disposed on a lower portion of the front plate 410. The support wheels 415 may be rotatably disposed on a rear surface of the front plate 410. The support wheels 415 may rotate while being in contact with a lower portion of the drum 200.

When the drum 200 is rotated by the driver, the drum 200 may be supported by the drum rotation shaft 6341 connected to the rear portion thereof. When the laundry is accommodated in the drum 200, a load applied to the drum rotation shaft 6341 may be increased by the laundry. Accordingly, there is a risk that the drum rotation shaft 6341 is bent by the load.

When the support wheels 415 support a front lower portion of the drum 200, the load applied to the drum rotation shaft 6341 may be reduced. Accordingly, the drum rotation shaft 6341 may be prevented from being bent and noise may be prevented from occurring by vibration.

The support wheels 415 may be disposed at locations symmetrical to each other with respect to a center of rotation of the drum 200 to support the load of the drum 200. It is preferable that the support wheels 415 are respectively disposed at left and right lower portions of the drum 200 to support the drum 200. However, the present disclosure may not be limited thereto, and a larger number of support wheels 415 may be disposed based on an operating environment of the drum 200.

The circulation duct 820 disposed in the base 800 may form a flow channel through which air inside the drum 200 is circulated and introduced into the drum 200 again.

The circulation duct 820 may include an inflow duct 821 through which air discharged from the drum 200 is introduced, an outflow duct 823 that supplies air to the drum 200, and a movement duct 822 that connects the inflow duct 821 with the outflow duct 823.

When air is discharged from the front portion of the drum 200, the movement duct 822 may be located at a front portion of the circulation duct 820. In addition, the outflow duct 823 may be located at a rear portion of the circulation duct 820.

The outflow duct 823 may further include an air blowing duct 8231 that discharges air to the outside of the circulation duct 820. The air blowing duct 8231 may be disposed at a rear portion of the outflow duct 823. Air discharged via the air blowing duct 8231 may move to the drum 200.

A duct cover 830 may be coupled to an upper portion of the circulation duct 820 to partially shield an open top surface of the circulation duct 820. The duct cover 830 may prevent air from being discharged to the outside of the circulation duct 820. In other words, the duct cover 830 may form one surface of the flow channel through which air circulates.

In addition, the heat exchanger part 900 disposed in the base 800 may include an evaporator 910 disposed inside the circulation duct 820 to cool air, and a condenser 920 disposed inside the circulation duct 820 to heat air cooled by the evaporator 910.

The evaporator 910 may dehumidify air discharged from the drum 200, and the condenser 920 may heat dehumidified air. Heated air may be supplied to the drum 200 again to dry the laundry accommodated in the drum 200.

The evaporator 910 and the condenser 920 may be equipped as heat exchangers through which a refrigerant flows.

The refrigerant moving along the evaporator 910 and the condenser 920 may exchange heat with air discharged from the drum 200.

The heat exchanger part 900 may include a circulation flow channel fan 950 installed in the circulation duct 820 to generate an air flow inside the circulation duct 820. In addition, the heat exchanger part 900 may further include a circulation flow channel fan motor 951 that rotates the circulation flow channel fan 950. The circulation flow channel fan 950 may rotate by receiving rotational power by the circulation flow channel fan motor 951. When the circulation flow channel fan 950 operates, air dehumidified by the evaporator 910 and heated by the condenser 920 may move to the rear portion of the drum 200.

The circulation flow channel fan 950 may be installed in one of the inflow duct 821, the movement duct 822, and the outflow duct 823. Because the circulation flow channel fan 950 is designed to rotate, noise may occur when the circulation flow channel fan 950 operates. Therefore, it is preferable that the circulation flow channel fan 950 is disposed in a rear portion of the circulation duct 820.

The circulation flow channel fan 950 may be installed in the air blowing duct 8231. In addition, the circulation flow channel fan motor 951 may be located in a rear portion of the air blowing duct 8231. When the circulation flow channel fan 950 is rotated by the circulation flow channel fan motor 951, air inside the circulation duct 820 may be discharged to the outside of the circulation duct 820 via the air blowing duct 8231.

For the user to easily withdraw the laundry located inside the drum 200, it is preferable that the drum inlet 211 of the drum 200 is defined at a relatively high location, and thus it is preferable that the circulation duct 820 and the heat exchanger part 900 are disposed under the drum 200.

The rear plate 420 that guides air discharged from the circulation duct 820 to the drum 200 may be disposed at the rear of the drum 200. The rear plate 420 may be spaced apart from the drum rear surface 220. The circulation duct 820 may receive air inside the drum 200 via the front plate 410 and supply air to the drum 200 via the rear plate 420. Air discharged from the circulation duct 820 may pass through the rear plate 420 and be guided to the drum 200.

The base 800 may further include a connector 850 that guides air discharged from the circulation duct 820 to the rear plate 420. The connector 850 may induce the discharged air to be evenly spread throughout the rear plate 420.

The connector 850 may be installed in the air blowing duct 8231. That is, the connector 850 may guide air discharged from the air blowing duct 8231 to the rear plate 420. Hot air supplied to the rear plate 420 may be introduced into the drum 200 via the drum rear surface 220.

The drum 200 of the laundry treating apparatus of the present disclosure may rotate by being directly connected to the driver located at the rear of the drum 200, rather than indirectly rotating by being coupled to a belt or the like. Therefore, unlike a drum of an existing dryer formed in a cylindrical shape having open front and rear portions, the rear portion of the drum of the laundry treating apparatus of the present disclosure may be shielded and directly coupled to the driver.

As described above, the drum 200 may include the drum body 210 formed in the cylindrical shape to accommodate the laundry therein, and the drum rear surface 220 coupled to the rear portion of the drum body 210 to form the rear surface of the drum.

The drum rear surface 220 may shield the rear portion of the drum body 210 and provide a coupling surface directly coupled to the driver. That is, the drum rear surface 220 may be connected to the driver and receive the rotational power to rotate the entire drum 200. As a result, the front portion of the drum body 210 may be formed with the drum inlet 211 into which the laundry is inserted, and the rear portion thereof may be shielded by the drum rear surface 220.

A bushing 300 connecting the driver with the drum rear surface 220 may be disposed on the drum rear surface 220. The bushing 300 may be disposed on the drum rear surface 220 and form the center of rotation of the drum 200. The bushing 300 may be integrally formed with the drum rear surface 220, but may be made of a material having greater rigidity or durability than the drum rear surface 220 to be firmly coupled to the rotation shaft that transmits the power. The bushing 300 may be seated on and coupled to the drum rear surface 220 to be coaxial with a center of rotation of the drum rear surface 220.

The drum rear surface 220 may include a circumferential portion 221 coupled to the outer circumferential surface of the drum body 210 and a mounting plate 222 disposed inward of the circumferential portion 221 to be coupled to the driver. The bushing 300 may be seated on and coupled to the mounting plate 222. The rotation shaft that rotates the drum may be coupled to the mounting plate 222 via the bushing 300 to be more firmly coupled. In addition, deformation of the drum rear surface 220 may be prevented from occurring.

The drum rear surface 220 may include a suction hole 224 extending therethrough and defined between the circumferential portion 221 and the mounting plate 222, and allowing front and rear portions of the drum rear surface 220 to be in communication with each other. Hot air supplied via the circulation duct 820 may be introduced into the drum body 210 via the suction hole 224. The suction hole 224 may be defined as a plurality of holes extending through the drum rear surface 220 or may be formed as a mesh-shaped net.

The driver that rotates the drum 200 may be positioned at the rear of the rear plate 420. The driver may include the motor 500 that generates the rotational power and the decelerator 600 that reduces the rotational force of the motor 500 and transmits the reduced rotational force to the drum 200.

The motor 500 may be disposed at the rear of the rear plate 420. Further, the motor 500 may be coupled to a rear portion of the rear plate 420 via the decelerator 600.

The decelerator 600 may be fixed to a rear surface of the rear plate 420, and the motor 500 may be coupled to a rear surface of the decelerator 600. That is, the rear plate 420 may provide a support surface on which the decelerator 600 or the motor 500 is supported. However, the present disclosure may not be limited thereto, and the motor 500 may be coupled to the rear plate 420.

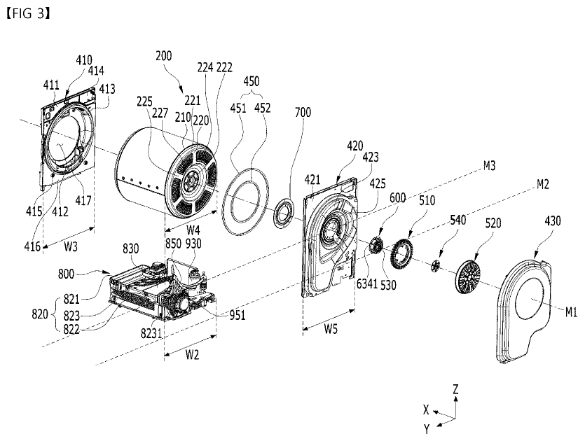

FIG. 3 is an exploded perspective view illustrating internal components constituting a laundry treating apparatus separated from each other.

The laundry treating apparatus according to an embodiment of the present disclosure may include the drum 200 that accommodates the laundry therein, the front plate 410 that supports the front surface of the drum, the rear plate 420 positioned at the rear of the drum, the base 800 that is disposed under the drum to provide a space in which air inside the drum circulates or moisture contained in the air condenses, a motor 510, 520, and 540 that is positioned at the rear of the drum and provides the rotational power to the drum, the decelerator 600 that decelerates the rotation of the motor and transmits the decelerated rotation to the drum, and a rear cover 430 that is coupled to the rear plate 420 and prevents the motor from being exposed to the outside.

The base 800 may include the circulation duct 820 that is in communication with the drum 200 to allow air to be introduced from the drum or to discharge air to the drum.

The front plate 410 may include the front panel 411 forming the front surface, and the drum inlet communication hole 412 defined to extend through the front panel 411 and in communication with the drum 200. The front plate 410 may include a front gasket 413 that is disposed on a rear surface of the front panel 411 and surrounds a radially outer side of the drum inlet communication hole 412 to accommodate a portion of the drum body 210 therein.

The front gasket 413 may rotatably support the drum body 210 and may be in contact with an outer circumferential surface or an inner circumferential surface of the drum inlet 211. The front gasket 413 may prevent hot air inside the drum 200 from leaking between the drum body 210 and the front plate 410. The front gasket 413 may be made of a plastic resin-based material or an elastic body, and a separate sealing member may be additionally coupled to the front gasket 413 to prevent the laundry or hot air from being deviated from the drum body 210 to the front plate 410.

In one example, the front plate 410 may include the duct communication hole 417 defined through an inner circumferential surface of the drum inlet communication hole 412. In addition, the front plate 410 may include the duct connection portion 416 extending downward of the duct communication hole 417 to form a flow channel allowing the drum body 210 and the circulation duct 820 to be in communication with each other.

The duct connection portion 416 may be in communication with the drum body 210 via the duct communication hole 417, and air discharged from the drum body 210 may be introduced into the duct connection portion 416 via the duct communication hole 417 and guided to the circulation duct 820. Because air discharged from the drum body 210 is guided to the circulation duct 820 by the duct connection portion 416, there is an effect of preventing leakage of air inside the drum.

A filter member (not shown) that filters the foreign substances or the lint from air discharged from the drum 200 to prevent the foreign substances from being introduced into the circulation duct 820 may be installed in the duct connection portion 416.

The front plate 410 may include support wheels 415 that are rotatably installed on the rear surface of the front panel 411 and support the lower portion of the drum 200. The support wheels 415 support the front portion of the drum 200, thereby preventing the rotation shaft connected to the drum from being bent.

The front plate 410 may include a water storage tank support hole 414 that is defined to extend through the front panel 411 and allows the water storage tank 120 (see FIG. 1) in which condensate generated in the drying process is stored to be extended or supported. When the water storage tank support hole 414 is defined at an upper side, the user does not have to bend the waist when extending the water storage tank, thereby increasing the user convenience.

The drum 200 accommodating the laundry therein may include the drum body 210 having the drum inlet 211 defined therein through which the laundry enters and exits, and the drum rear surface 220 forming the rear surface.

The drum rear surface 220 may include the circumferential portion 221 connected to the drum body 210, the suction hole 224 defined inward of the circumferential portion 221 to extend through the drum rear surface 220, and the mounting plate 222 disposed at the center of rotation of the drum rear surface 220 and coupled to the rotation shaft. Air may be introduced to the rear portion of the drum via the suction hole 224.

The drum rear surface 220 may further include a reinforcing rib 225 extending from the circumferential portion 221 toward the center of rotation. The reinforcing rib 225 may extend while avoiding the suction hole 224. The reinforcing rib 225 may prevent the rigidity of the drum rear surface 220 from being reduced by the suction hole 224. The reinforcing rib 225 may extend radially from an outer circumferential surface of the mounting plate 222 toward an inner circumferential surface of the circumferential portion 221.

In addition, the drum rear surface 220 may further include a circumferential rib 227 extending in a circumferential direction of the drum rear surface 220 to connect the reinforcing ribs 225 to each other. Each suction hole 224 may be disposed between each pair of reinforcing ribs 225 and also between the circumferential rib 227 and the circumferential portion 221. The reinforcing rib 225 and the circumferential rib 227 may prevent the drum rear surface 220 from being deformed even when receiving the rotational force from the motor 500.

The inflow duct 821 may be in communication with the duct communication hole 417 of the front plate 410 and be in communication with the flow channel installed inside the front plate 410. The movement duct 822 may extend from a distal end of the inflow duct 821 toward the rear portion of the drum 200, and the outflow duct 823 may be disposed at a distal end of the movement duct 822 to guide the air to the drum 200.

The air blowing duct 8231 may be located at a downstream side of the outflow duct 823, and the air blowing duct 8231 may provide a space in which the circulation flow channel fan is installed. When the circulation flow channel fan operates, air introduced into the inflow duct 821 may be discharged to an upper portion of the blower duct 8231.

In one example, the heat exchanger part 900 capable of cooling and heating air circulating inside the drum 200 may be installed in the base 800. The heat exchanger part 900 may include a compressor 930 that is connected to the evaporator and the condenser and supplies a compressed refrigerant. The compressor 930 may be designed so as not to directly exchange heat with circulating air, and may be located outside the circulation duct 820.

In addition, the heat exchanger part may include the circulation flow channel fan motor 951 that is supported at a rear portion of the air blowing duct 8231 and rotates the circulation flow channel fan. The circulation flow channel fan motor 951 may be coupled to the rear portion of the air blowing duct 8231.

In one example, the laundry treating apparatus according to an embodiment of the present disclosure may further include the connector 850 that is coupled to the circulation duct 820 and guides hot air discharged from the circulation duct 820 to the rear portion of the drum 200 or to the rear plate 420.

The connector 850 may be disposed upward of the outflow duct 823 and guide hot air heated by passing through the condenser 920 upward of the outflow duct 823. In addition, the connector 850 may be coupled to an opening defined at an upper side of the air blowing duct 8231.

The connector 850 may be formed to define a flow channel therein. The connector 850 may evenly guide the flow of air generated by the circulation flow channel fan to the rear plate 420. That is, the connector 850 may be formed such that an area size of the flow channel increases as a distance from the air blowing duct 8231 increases.

The rear plate 420 may be coupled to the base 800 or supported by the base 800 and be positioned at the rear of the drum 200. The rear plate 420 may include a rear panel 421 positioned to face the front plate 410, and a rear plate duct 423 that is recessed in the rear panel 421 to form a flow channel through which air flows and to guide air discharged from the circulation duct 820 to the drum.

The rear plate 420 may include a mounting portion 425 to which the driver is coupled or supported. The mounting portion 425 may extend through the rear panel 421, and may be disposed in an inner circumferential surface of the rear plate duct 423. The mounting portion 425 may be spaced apart from the inner circumferential surface of the rear plate duct 423 in a radially inward direction.

Herein, as described above, the driver may refer to a combination of the decelerator 600 and the motor 500. In addition, the driver may mean only the motor 500. That is, a component that generates the power and transmits the rotational power to the drum may be referred to as the driver.

The driver may be mounted in the mounting portion 425. The mounting portion 425 may support a load of the driver. The driver may be connected to the drum 200 while being supported by the mounting portion 425.

The rear plate duct 423 may accommodate a portion of the drum rear surface 220 therein. The rear plate duct 423 may define a flow channel through which air moves together with the drum rear surface 220.

The driver may be installed in the mounting portion 425 so as to be prevented from interfering with the rear plate duct 423. In other words. The driver may be disposed to be spaced radially inward apart from the inner circumferential surface of the rear plate duct 423. The driver may be installed in the mounting portion 425, but may be installed such that a rear portion thereof is exposed to the outside, and be cooled by external air.

The driver may include the motor 500 that provides the power to rotate the drum 200. The motor 500 may include a stator 510 that generates a rotating magnetic field and a rotor 520 that is rotated by the stator 510.

The rotor 520 may be of an outer rotor type that accommodates the stator 510 therein and rotates along a circumference of the stator 510. In this regard, a driving shaft may be coupled to the rotor 520, extend through the stator 510 and the mounting portion 425, and be directly connected to the drum 200. In this case, the rotor 520 may directly transmit the power for rotating the drum 200.

The rotor 520 may be coupled to the driving shaft via a washer 540. The washer 540 may perform a function of connecting the driving shaft with the rotor 520. Because a contact area between the rotor 520 and the driving shaft may be increased by the washer 540, the rotation of the rotor 520 may be more effectively transmitted.

The decelerator 600 may connect the motor 500 with the drum 200. The decelerator 600 may rotate the drum 200 by converting the power of the motor 500. The decelerator 600 may be disposed between the motor 500 and the drum 200, receive the power from the motor 500, convert the power, and transmit the converted power to the drum 200. The decelerator 600 may convert an RPM of the rotor into a lower RPM while increasing a torque value and transmit the increased torque value to the drum 200.

Specifically, the decelerator 600 may be coupled to the driving shaft that is coupled to the rotor 520 and rotates together with the rotor 520. The decelerator 600 may include a gear assembly that rotates in engagement with the driving shaft and converts an rpm of the driving shaft while increasing a torque, and the gear assembly may be coupled to the drum 200 to be connected to the drum rotation shaft that rotates the drum. Accordingly, when a driving shaft 530 rotates, the drum rotation shaft may rotate at a lower rpm than the driving shaft, but may rotate with a greater torque.

A performance of such a decelerator 600 may depend on whether the driving shaft and the drum rotation shaft are able to remain coaxial with each other. That is, when the driving shaft and the drum rotation shaft are misaligned, there is a risk that components constituting the gear assembly inside the decelerator 600 may be loosely engaged with or disengaged from at least one of the driving shaft and the drum rotation shaft. Therefore, the power of the driving shaft may not be properly transmitted to the drum rotation shaft or the driving shaft may rotate idly.

In addition, even when the driving shaft and the drum rotation shaft are temporarily misaligned, gears inside the decelerator 600 may be misaligned and collide with each other, thereby causing unnecessary vibration or noise.

In addition, when an angle at which the driving shaft and the drum rotation shaft are temporarily misaligned becomes greater, there is a risk that the decelerator 600 may completely deviate from a correct location or be damaged.

To prevent this, it is preferable that the laundry treating apparatuses equipped with the decelerators fix the decelerator 600 and the motor 500 to a support that maintains an original state thereof without deformation even when an external force is generated.

For example, in a case of the washing machine, a method of primarily fixing the tub accommodating the drum therein to the cabinet and secondarily fixing the motor and the decelerator to a bearing housing made of a rigid body embedded in the tub by injection molding may be applied. Accordingly, even when significant vibration occurs in the tub, the decelerator and the driver may be inclined or vibrated together with the bearing housing or a fixing steel plate. As a result, the decelerator and the driver itself may always maintain the coupled state as it is, and the driving shaft and the rotation shaft may be maintained in the coaxial state.

However, because the laundry treating apparatus of the present disclosure is equipped as the dryer, the tub fixed inside the cabinet is omitted. In addition, because the rear panel of the cabinet is formed as a relatively thin plate, even when the stator 510 is fixed, the rear panel may easily vibrate or bend by a repulsive force when the rotor 520 rotates. When the rear panel vibrates or bends even temporarily, there may be a problem in that centers of rotation of the decelerator 600 and the motor 500 disposed to be coupled to the drum 200 are misaligned with each other.

In addition, because the rear panel is formed as the thin steel plate, it may be difficult to support both the decelerator 600 and the motor 500. For example, when the decelerator 600 and the motor 500 are coupled to the rear panel in parallel with each other, a rotation moment may be generated by a total length and a self-weight of the decelerator 600 and the motor 500, and thus the decelerator 600 may sag downward. As a result, the drum rotation shaft itself coupled to the drum may be misaligned with the decelerator 600, and thus may not remain coaxial with the driving shaft.

Further, it may be considered that, as the stator 510 is coupled to the rear plate 420, the motor 500 is supported. When the large amount of laundry is accommodated in the drum 200 or eccentricity occurs, the drum rotation shaft may be misaligned along an arrangement of the laundry items whenever the drum 200 rotates. In this regard, because the stator 510 is separated from the drum 200 and fixed to the rear plate 420, the drum rotation shaft may vibrate with a different width or be inclined at a different angle from that of the stator 510. Therefore, the drum rotation shaft and the driving shaft may not remain coaxial with each other.

In another aspect, the drum 200 may be supported by the front plate 410 and the rear plate 420, so that an installation location thereof may be fixed at a certain level. Accordingly, a location of the drum rotation shaft coupled to the drum 200 may also be fixed at a certain level. Therefore, even when the vibration occurs in the drum 200, the vibration may be buffered by at least one of the front plate 410 and the rear plate 420.

However, when the vibration occurring in the drum 200 is transmitted to the motor 500, even when the decelerator 600 and the motor 500 are fixed to the rear plate 420, a vibration width of the motor 500 and the rear plate 420 may be greater than a vibration width of the drum rotation shaft. Even in this case, there may be a problem that the driving shaft and the drum rotation shaft are not able to remain coaxial with each other.

To solve this problem, the laundry treating apparatus of the present disclosure may fix the motor 500 by coupling the same to the decelerator 600. In other words, the decelerator 600 itself may serve as a reference point of the entire driver. That is, the decelerator 600 may serve as a reference for the amounts of vibration and inclination of the entire driver.

Because the motor 500 is not fixed to another component of the laundry treating apparatus but is fixed only to the decelerator 600, when the vibration or the external force is transmitted to the driver, the motor 500 may always be inclined or vibrated simultaneously with the decelerator 600 when the decelerator 600 is inclined or vibrated.

As a result, the decelerator 600 and the motor 500 may form one vibration part, and the decelerator 600 and the motor 500 may be maintained in a fixed state without a relative movement therebetween.

The stator 510 of the motor 500 may be directly coupled and fixed to the decelerator 600. Accordingly, a location where the driving shaft 530 is installed with respect to the decelerator 600 may not be changed. The driving shaft 530 may be disposed such that a center thereof and a center of the decelerator 600 are coincident with each other, and the driving shaft 530 may rotate while remaining coaxial with the center of the decelerator 600.

A first axis M1 may refer to an imaginary line extending in a front and rear direction along the center of rotation of the drum 200. That is, the first axis M1 may be in parallel with an X axis.

A second axis M2 and a third axis M3 may refer to imaginary lines extending from a point in front of the laundry treating apparatus to a point at the rear of the laundry treating apparatus. That is, the second axis M2 and the third axis M3 may be in parallel with an XZ plane or be perpendicular to an Y axis.

The first axis M1 and the second axis M2 may intersect each other at the decelerator 600. In addition, the first axis M1 and the third axis M3 may intersect each other at the mounting portion 425.

The decelerator 600 and the motor 500 may be designed to be arranged along the first axis M1 parallel to the ground when there is no load on the drum 200 or when the motor 500 is not in operation.

However, when the vibration occurs in the drum 200 or the motor 500, the vibration is transmitted to the decelerator 600 and the decelerator 600 is inclined, so that the decelerator 600 may be temporarily inclined along the second axis M2.

In this regard, because the motor 500 is coupled to the decelerator 600, it may vibrate or be inclined together with the decelerator 600. Therefore, the motor 500 may be disposed in parallel with the decelerator 600 on the second axis M2. Thus, the driving shaft and the drum rotation shaft may also be arranged in parallel with each other along the second axis M2.

As a result, even when the decelerator 600 is inclined, the motor 500 may move integrally with the decelerator 600, and the driving shaft and the drum rotation shaft may remain coaxial with each other.

The decelerator 600 may be coupled to and fixed to the rear plate 420. In this case, because the decelerator 600 will be inclined or vibrated in the state of being coupled to the rear plate 420, it may be considered that the rear plate 420 serves as a center of a vibration part including the decelerator 600, the motor 500, and the drum 200. Even in this case, the motor 500 may not be directly coupled to the rear plate 420, but may be coupled and fixed only to the decelerator 600.

The decelerator 600, the motor 500, and the drum 200 may be arranged in parallel with each other along the first axis M1, and then the decelerator 600 may be inclined in parallel with the third axis M3 by the vibration of the drum 200 or the motor 500. The third shaft M3 may pass through the decelerator 600 coupled to the rear plate 420. In this regard, because the decelerator 600 and the motor 500 are coupled to each other, the motor 500 may also be inclined in parallel with the third axis M3 in the same manner as the decelerator 600.

As a result, the motor 500 and the drum 200 are coupled to the decelerator 600, so that the motor 500 and the drum 200 may be inclined in parallel with each other or simultaneously vibrate with respect to the decelerator 600.

The above-described terms “coaxial” and “coincident” do not refer to a physically perfect coaxial or coincident state, but rather encompass a range of tolerances that are mechanically acceptable or considered coaxial or coincident by a person skilled in the art. For example, the driving shaft 530 and the drum rotation shaft 6341 may be defined to be in the coaxial or coincident state even when they are misaligned with each other within 5 degrees. However, such an angle value is merely an example, and the tolerance allowable in the design may vary.

Because the driving shaft 530 rotates with respect to the decelerator 600, but is fixed so as not to be inclined, and the stator 510 is also fixed to the decelerator 600, a gap between the stator 510 and the rotor 520 may be maintained at all times. As a result, collision between the stator 510 and the rotor 520 may be prevented, and noise or vibration that may occur by a change in a center of rotation while the rotor 520 rotates about the stator 510 may be fundamentally blocked.

The drum rotation shaft 6341 may extend toward the drum 200 from inside the decelerator 600, may vibrate together with the decelerator 600, and may be inclined together with the decelerator 600. That is, the drum rotation shaft 6341 may be designed only to rotate in the decelerator 600, and may have a fixed installation location. As a result, the drum rotation shaft 6341 and the driving shaft 530 may be always arranged in parallel with each other, and may be coaxial with each other. In other words, a center of the drum rotation shaft 6341 and a center of the driving shaft 530 may remain coincident with each other.

In one example, a sealing member 450 may be disposed between the drum rear surface 220 and the rear plate 420. The sealing member 450 may seal a space between the drum rear surface 220 and the rear plate 420 such that air introduced into the rear plate duct 423 of the rear plate 420 is introduced into the suction hole 224 without leaking to the outside.

The sealing member 450 may be disposed on an outer surface and an inner surface of the rear plate duct 423. A first sealing 451 may be disposed on a radially outer side of the rear plate duct 423 and a second sealing 452 may be disposed on a radially inner side of the rear plate duct 423. The first sealing 451 may prevent hot air from leaking radially outward between the drum rear surface 220 and the rear plate duct 423, and the second sealing 452 may prevent hot air from leaking radially inward between the drum rear surface 220 and the rear plate duct 423.

In other words, the sealing member 450 may be disposed radially outward of and radially inward of the suction hole 224. The first sealing 451 may be disposed radially outward of the suction hole 224, and the second sealing 452 may be disposed radially inward of the suction hole 224.

The sealing member 450 may be disposed so as to be in contact with both the drum rear surface 220 and the rear plate 420 to prevent hot air from leaking. Because the drum 200 rotates during the operation of the laundry treating apparatus, continuous friction is applied to the sealing member 450 by the drum rear surface 220. Therefore, it will be preferable that the sealing member 450 is made of a material capable of sealing the space between the drum rear surface 220 and the rear plate duct 423 without deteriorating a performance even with a frictional force and frictional heat generated by the rotation.

In one example, the motor 500 or the decelerator 600 may be coupled to a rear portion of the rear plate 420. Because the rear plate 420 may be formed as a thin iron plate, there is a possibility that the rear plate 420 may be bent or deformed by the decelerator 600 and a load transmitted to the decelerator 600 by the drum 200. That is, to install the decelerator 600, the motor 500, and the like, the rigidity of the rear plate 420 needs to be secured.

To this end, the rear plate 420 may further include a bracket 700 for reinforcing coupling rigidity. The bracket 700 may be additionally coupled to the rear plate 420, and the decelerator 600 and the motor 500 may be coupled to the rear plate 420 by the bracket 700.

The decelerator 600 may be simultaneously coupled to the bracket 700 and the rear plate 420. A fastening member may simultaneously extend through the decelerator 600, the rear plate 420, and the bracket 700 to couple them together. The rear plate 420 may secure the rigidity thereof as the bracket 700 is coupled thereto. The decelerator 600, the motor 500, and the like may be coupled to the rear plate 420 whose rigidity is secured.

The decelerator 600 may be coupled to the bracket 700 first and then the bracket 700 may be coupled to the rear plate 420. That is, the decelerator may be fixed to the rear plate 420 via the bracket 700 without being directly coupled to the rear plate 420.

In one example, when the motor 500 or the decelerator 600 is coupled to the rear portion of the rear plate 420, the motor 500 and the decelerator 600 may be exposed to the outside. Therefore, it is necessary to prevent the motor 500 from being exposed by being coupled to the rear portion of the rear plate 420. In addition, the rear plate duct 423 may be heated by hot air. Therefore, it may be necessary to insulate a rear surface of the rear plate duct 423.

The rear cover 430 may be coupled to the rear portion of the rear plate 420 to prevent the rear plate duct 423 and the motor 500 or the decelerator 600 from being exposed to the outside. The rear cover 430 may be disposed to be spaced apart from the rear plate duct 423 and the driver.

The rear cover 430 may prevent the motor 500 from being damaged by external interference, or prevent a decrease in the drying efficiency resulted from a heat loss occurring through the rear plate duct 423.

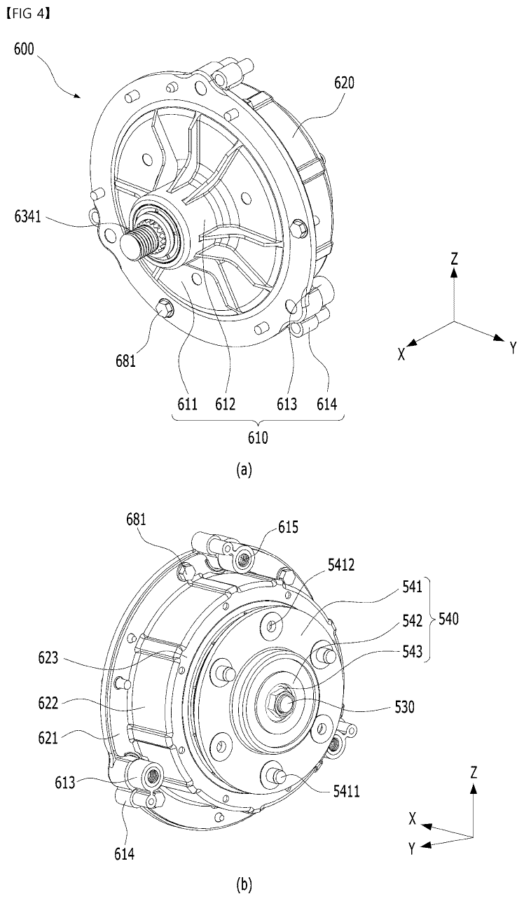

FIG. 4 illustrates an outer appearance of a decelerator according to an embodiment of the present disclosure.

The decelerator 600 may include a decelerator housing 610 and 620 forming an outer appearance thereof. The decelerator housing may include a first housing 610 facing the drum and a second housing 620 facing the motor.

The decelerator 600 may include a gear box. The gear box may be designed to receive the power from the motor, convert the RPM of the motor into the lower RPM while increasing the torque value, and transmit the increased torque value to the drum. A substantial portion of the gear boxes may be accommodated in the second housing 620, and the first housing 610 may shield the inside of the decelerator 600. Accordingly, an overall thickness of the decelerator 600 may be reduced. A detailed configuration of the gearbox will be described later.

The first housing 610 may include a first housing shielding body 611 that shields the second housing 620 and a first housing shaft accommodating portion 612 extending from the first housing shielding body 611 in a direction away from the second housing 620. The first housing shaft accommodating portion 612 may accommodate the drum rotation shaft 6341 therein and may rotatably support the drum rotation shaft 6341.

The first housing 610 may include a stator coupling portion 613 that supports the motor. The stator coupling portion 613 may extend from a circumferential surface of the first housing shielding body 611 in a direction away from the first housing shaft accommodating portion 612.

The stator coupling portion 613 may include a stator fastening hole 615 into which the motor may be fastened. The stator fastening hole 615 may be recessed in the stator coupling portion 613. A separate fastening member may be inserted into the stator fastening hole 615. The stator coupling portion 613 and the motor may be coupled to each other using the fastening member.

The first housing 610 may further include a coupling guide 614 that guides the coupling of the motor. The coupling guide 614 may extend from the circumferential surface of the first housing shielding body 611 in the direction away from the first housing shaft accommodating portion 612. The coupling guide 614 may extend from the first housing shielding body 611 to be connected to the stator coupling portion 613. The coupling guide 614 may guide a location of the stator 510 when the stator 510 is coupled to the stator coupling portion 613. Accordingly, assemblability may be improved.

Referring to FIG. 4, the second housing 620 may accommodate the gear assembly therein. In general, the gear box coupled to the decelerator 600 may include a sun gear, a planetary gear that revolves around the sun gear, and a ring gear that accommodates the planetary gear therein and induces the planetary gear to rotate. The second housing 620 may include a second housing coupling body 621 coupled to the first housing 610, a second housing shielding body 622 extending from the second housing coupling body 621 in a direction away from the first housing 610 to define a space in which the gear box is accommodated, and a second housing shaft accommodating portion extending away from the first housing 610 from an inner circumferential surface of the second housing shielding body 622 to support the driving shaft 530.

A center of the first housing 610 and a center of the second housing 620 may be designed to be coaxial with each other. It is advantageous for power transmission that the driving shaft 540 and the drum rotation shaft 6341 are coaxial with each other. Accordingly, it is preferable that the first housing shaft accommodating portion 612 that rotatably supports the drum rotation shaft 6341 and the second housing shaft accommodating portion that rotatably supports the driving shaft 540 are coupled to each other to be coaxial with each other.

The driving shaft 530 may be inserted into the second housing 620 and rotatably supported in the second housing 620. The washer 540 rotatably supporting the rotor 520 may be coupled to the driving shaft 530. The washer 540 may include an accommodating body 542 having a shaft support hole 543 defined at the center thereof to accommodate the driving shaft 530 therein, and a washer coupling body 541 extending radially from an outer circumferential surface of the accommodating body to form a surface to which the rotor is coupled. The shaft support hole 543 may be defined in a groove shape corresponding to a protrusion such that the protrusion formed on an outer circumferential surface of the driving shaft 530 may be coupled thereto.

The washer 540 may include one or more washer coupling protrusions 5411 protruding from the washer coupling body 541 in a direction away from the decelerator. In addition, the washer 540 may include one or more washer coupling holes 5412 extending through the washer coupling body 541.

The washer coupling protrusion 5411 may be coupled to an accommodating groove defined in the rotor. A washer coupling hole 5412 may be used to couple the rotor with the washer 540 by inserting a fastening member extending through the rotor thereinto.

The washer coupling protrusion 5411 and the washer coupling hole 5412 may be alternately positioned on a surface of the washer coupling body 541 along a circumferential direction, and thus the washer coupling protrusion 5411 and the washer coupling hole 5412 may include a plurality of washer coupling protrusions and a plurality of washer coupling hole, respectively.

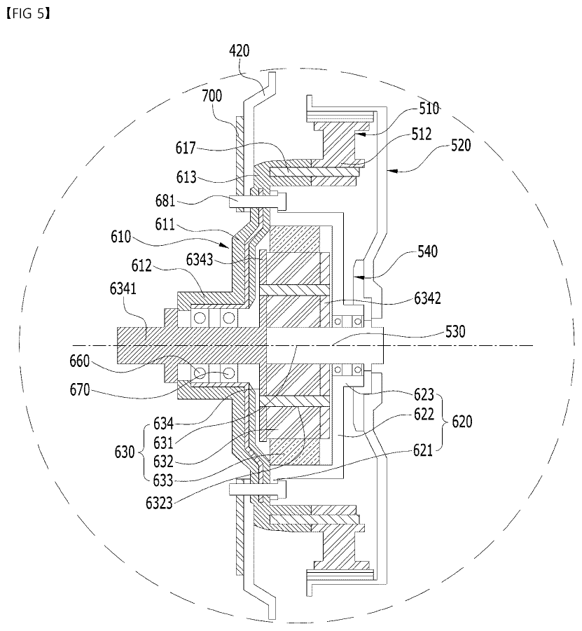

FIG. 5 is a cross-sectional view of a driver.

The driver may include the motor 500 that generates the rotational power and the decelerator that reduces the rotational speed of the motor 500 and transmits the reduced rotational speed to the drum. The decelerator 600 may include the drum rotation shaft 6341 that rotates the drum.

The motor 500 may include the stator 510 that receives the external power and generates the rotating magnetic field and the rotor 520 that surrounds the outer circumferential surface of the stator 510. A permanent magnet may be disposed on an inner circumferential surface of the rotor 520.

The permanent magnet positioned on the inner circumferential surface of the rotor 520 may move in a specific direction by the rotating magnetic field generated in the stator 510, and the permanent magnet may be fixed to the inner circumferential surface of the rotor 520. Accordingly, the rotor 520 may rotate by the rotating magnetic field of the stator 510.

The driving shaft 530 that rotates together with the rotor 520 and transmits the rotational power of the rotor 520 may be coupled to the center of rotation of the rotor 520. The driving shaft 530 may rotate together with the rotor 540. The driving shaft 530 may be coupled to the rotor 540 via the washer 540.

The driving shaft 530 may be directly connected to the rotor 520, but when connected thereto via the washer 540, may be more firmly coupled to the rotor 520, thereby more effectively transmitting the rotational force of the rotor 520. In addition, there is an effect of increasing durability of the driving shaft 530 by preventing a load from being intensively applied to the driving shaft 530.

The driving shaft 530 may be directly connected to the drum, but because the driving shaft 530 rotates at a speed equal to the rotation speed of the rotor 520, deceleration may be required. Accordingly, the driving shaft 530 may be connected to the decelerator, and the decelerator may be connected to the drum. That is, the decelerator may decelerate the rotation of the driving shaft 530 and rotate the drum.

The decelerator 600 may include the first housing 610 and the second housing 620 forming the outer appearance thereof, and a gear box 630 that reduces the power of the driving shaft 530. The second housing 620 may provide the space capable of accommodating the gear box 630, and the first housing 610 may shield the accommodation space provided by the second housing 620.

The second housing 620 may be composed of the second housing coupling body 621 coupled to the first housing 610, the second housing shielding body 622 extending rearward from an inner circumferential surface of the second housing coupling body 621 to define the accommodation space and accommodating the gear box 630 therein, and the second housing shaft accommodating portion 623 extending rearward from the second housing shielding body 622 to accommodate the driving shaft 530 therein.

The gear box 630 may include the ring gear 633 installed along the inner circumferential surface of the second housing shielding body 622. One or more planetary gears 632 that are gear-coupled to the ring gear 633 may be disposed on an inner circumferential surface of the ring gear 633, and the sun gear 631 that is gear-coupled to the planetary gear 632 and rotates together with the driving shaft 530 may be disposed inward of the ring gear 633.

The sun gear 631 may be coupled to the driving shaft 530 and rotate. The sun gear 631 may be formed as a separate member from the driving shaft 530, but the present disclosure may not be limited thereto, and the sun gear 631 may be integrally formed with the driving shaft 530.

The sun gear 631, the planetary gear 632, and the ring gear 633 may be formed as helical gears. When each gear is formed as the helical gear, noise may be reduced and power transmission efficiency may be increased. However, the present disclosure may not be limited thereto, and the sun gear 631, the planetary gear 632, and the ring gear 633 may be formed as spur gears.

As an example of the operation of the gear box 630, when the driving shaft 530 and the sun gear 631 connected to the driving shaft 530 rotate as the rotor rotates, the planetary gear 632 gear-coupled to an outer circumferential surface of the sun gear 631 may be gear-coupled between the ring gear 633 and the sun gear 631 and rotate.

The planetary gear 632 may include a planetary gear shaft 6323 inserted into a center of rotation thereof. The planetary gear shaft 6323 may rotatably support the planetary gear 632.

The decelerator may further include a first carrier 6342 and a second carrier 6343 supporting the planetary gear shaft 6323. The planetary gear shaft 6323 may be supported by the second carrier 6343 at a front side and may be supported by the first carrier 6342 at a rear side.

The drum rotation shaft 6341 may extend in a direction away from the motor from a center of rotation of the second carrier 6343. The drum rotation shaft 6341 may be formed as a separate component from the second carrier 6343 and may be coupled to the second carrier 6343 to rotate together. On the other hand, the drum rotation shaft 6341 may extend from the second carrier 6343 and may be integrally formed with the second carrier 6343.

The drum rotation shaft 6341 may be coupled to the drum and rotate the drum. As described above, the drum rotation shaft 6341 may be coupled to the drum via a connector such as the bushing, or may be directly coupled to the drum without the separate connector.

The drum rotation shaft 6341 may be supported by the first housing 610. The first housing 610 may include the first housing shielding body 611 that shields the accommodation space of the second housing 620 and the first housing shaft accommodating portion 612 that extends from the first housing shielding body 611 in a direction away from the second housing 620 and accommodates the drum rotation shaft 6341 therein. A first bearing 660 and a second bearing 670 may be press-fitted into an inner circumferential surface of the first housing shaft accommodating portion 612 and rotatably support the drum rotation shaft 6341.

The first housing 610 and the second housing 620 may be coupled to each other via a decelerator fastening member 681. In addition, the decelerator fastening member 681 may simultaneously extend through the first housing 610 and the second housing 620 to couple both members to each other. In addition, the decelerator fastening member 681 may simultaneously extend through the first housing 610, the second housing 620, and the rear plate 420 to couple the first housing 610 with the second housing 620 and simultaneously fix the decelerator 600 to the rear plate 420.

The rear plate 420 may be formed as the thin iron plate. Accordingly, it may be difficult to secure rigidity for supporting all of the decelerator 600, the motor 500 coupled to the decelerator 600, and the drum 200 connected to the decelerator 600. Accordingly, the bracket 700 may be used to secure the rigidity of the rear plate 420 when the decelerator 600 is coupled to the rear plate 420. The bracket 700 may be made of a material having a greater rigidity than the rear plate 420 and may be coupled to a front surface or a rear surface of the rear plate 420.

The bracket 700 may be coupled to the front surface of the rear plate 420 to secure the rigidity for the decelerator 600 to be coupled, and the decelerator 600 may be simultaneously coupled to the rear plate 420 and the bracket 700. A fastening member such as a bolt may be used to couple the rear plate 420, the bracket 700, and the decelerator to each other.

In addition, to fix the decelerator 600 to the rear plate 420, the decelerator fastening member 681 used to couple the first housing 610 with the second housing 620 may be used. That is, the decelerator fastening member 681 may extend through the second housing 620, the first housing, the rear plate 420, and the bracket 700 and couple them together at once. When they are coupled as such, the rear plate 420 may be supported by the bracket 700 at a front side and by the first housing 610 at a rear side, so that the rigidity thereof may be secured even when the decelerator 600 is coupled thereto. However, the present disclosure may not be limited thereto, and first, only the first housing 610 and the second housing 620 may be coupled to each other using the decelerator fastening member 681, and then the decelerator 600 may be coupled to the rear plate 420 using a separate fastening member.

In addition, the stator coupling portion 613 to which the motor 500 may be coupled may be formed radially outward of the first housing 610. The stator coupling portion 613 may include a coupling groove defined to be recessed therefrom.

The stator 510 may be directly coupled to the rear plate 420, or may be coupled to the stator coupling portion 613. The stator 510 may include a fixing rib 512 disposed on an inner circumferential surface thereof to support the same. The fixing rib 512 may be coupled to the stator coupling portion 613. The fixing rib 512 and the stator coupling portion 613 may be coupled to each other by a stator coupling pin 617.

As the motor 500 is coupled to the decelerator 600 while being spaced apart from the rear plate 420, the motor 500 and the decelerator 600 may form one vibration part. Therefore, even when the vibration is applied from the outside, the driving shaft 530 coupled to the rotor 520 and the drum rotation shaft 6341 connected to the decelerator 600 may easily remain coaxial with each other.

There is a risk that the drum rotation shaft 6341 is misaligned by the vibration of the drum 200. However, because the motor 500 is coupled to the first housing 610 supporting the drum rotation shaft 6341, even when the drum rotation shaft 6341 is misaligned, the driving shaft 530 will also be misaligned similarly by the first housing 610. That is, the motor 500 may be moved integrally with the decelerator 600, and thus the drum rotation shaft 6341 and the driving shaft 530 may remain coaxial with each other even when a force is applied from the outside.

Because of the above-described coupling structure, efficiency and reliability of transmission of the power generated from the motor 500 to the drum 200 may be increased, and wear of the gear box 630, a decrease in the efficiency of the power transmission, and a decrease in durability and reliability, which occur by the misalignment of the drum rotation shaft 6341 and the driving shaft 530, may be prevented.

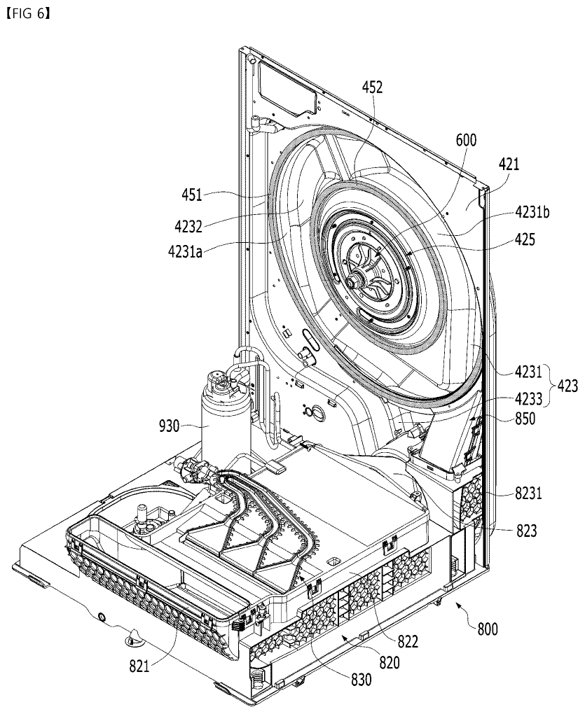

FIG. 6 illustrates a base and a rear plate according to an embodiment of the present disclosure.

Referring to FIG. 6, the rear plate 420 may be positioned at the rear of the drum. The rear plate 420 may guide hot air discharged from the circulation duct 820 to the drum. That is, the rear plate 420 may be positioned at the rear of the drum and form the flow channel such that hot air is evenly supplied to the entire drum.

The rear plate 420 may include the rear panel 421 facing the drum rear surface, and the rear plate duct 423 defined to be recessed rearward from the rear panel 421 to form the flow channel. The rear plate duct 423 may be pressed rearward from the rear panel 421. The rear plate duct 423 may partially accommodate the drum rear surface therein.

The rear plate duct 423 may include an inlet portion 4233 positioned at the rear of the circulation flow channel and a flow portion 4231 positioned at the rear of the drum. The flow portion 4231 may accommodate a portion of the drum therein. The flow portion 4231 may partially accommodate the drum therein to form a flow channel defined at the rear portion of the drum.

The flow portion 4231 may be formed in an annular shape to face the suction hole defined in the drum rear surface. The flow portion 4231 may be recessed in the rear panel 421. That is, the flow portion 4231 may have an open front side, and may define the flow channel together with the rear surface of the drum.

When the front side of the flow portion 4231 is open, hot air moved to the flow portion 4231 may be directly moved to the drum without passing through a separate component. Therefore, heat loss may be prevented from occurring as hot air passes through the separate component. That is, there is an effect of increasing the drying efficiency by reducing the heat loss of hot air.

The rear plate 420 may include the mounting portion 425 disposed radially inward of the flow portion 4231. The mounting portion 425 may provide a space to which the decelerator 600 or the motor 500 is coupled. That is, the rear plate 420 may include the mounting portion 425 disposed inward and the moving portion 4231 formed in the annular shape and disposed radially outward of the mounting portion 425.

Specifically, the flow portion 4231 may include a flow portion outer circumferential portion 4231a surrounding an inner space in which hot air flows from the outside. In addition, the flow portion 4231 may include a flow portion inner circumferential portion 4231b surrounding the inner space in which hot air flows from the inside. That is, the flow portion outer circumferential portion 4231a may form an outer circumference of the flow portion 4231, and the flow portion inner circumferential portion 4231b may form an inner circumference of the flow portion 4231.

In addition, the flow portion 4231 may include a flow portion recessed surface 4232 forming a rear surface of the flow channel through which hot air moves. The flow portion recessed surface 4232 may connect the flow portion outer circumferential portion 4231a with the flow portion inner circumferential portion 4231b. That is, the space through which hot air discharged from the circulation duct 820 flows may be defined by the flow portion inner circumferential portion 4231b, the flow portion outer circumferential portion 4231a, and the flow portion recessed surface 4232.

In addition, the flow portion recessed surface 4232 may prevent hot air from leaking rearward, thereby guiding hot air toward the drum. That is, the flow portion recessed surface 4232 may refer to a recessed surface of the flow portion 4231.

The inlet portion 4233 may be positioned to face the circulation duct 820. The inlet portion may be positioned to face the air blowing duct 8231. The inlet portion 4233 may be recessed rearward from the rear panel 421 so as to prevent interference with the air blowing duct 8231. An upper side of the inlet portion 4233 may be connected to the flow portion 4231.

The laundry treating apparatus according to an embodiment of the present disclosure may include the connector 850 connected to the air blowing duct 8231. The connector 850 may guide hot air discharged from the air blowing duct 8231 to the flow portion 4231. The connector 850 may have the flow channel defined therein to guide hot air discharged from the air blowing duct 4231 to the flow portion 4231. That is, the connector 850 may form the flow channel connecting the air blowing duct 8231 with the flow portion 4231. A cross-sectional area of the flow channel defined inside the connector 850 may increase as a distance from the air blowing duct 8231 increases.

The connector 850 may be positioned to face the inlet portion 4233. The inlet portion 4233 may be recessed rearward to prevent the interference with the connector 850. In addition, an upper end of the connector 850 may partition the flow portion 4231 and the inlet portion 4233 from each other. That is, hot air discharged from the connector 850 may be introduced into the flow portion 4231, but may be prevented from being introduced into the inlet portion 4233.

The connector 850 may evenly supply hot air to the flow portion 4231. The connector 850 may be formed such that a width thereof increases as a distance from the air blowing duct 8231 increases. The upper end of the connector 850 may be located along a circumferential extension line of the flow portion outer circumferential portion 4231a.

Accordingly, hot air discharged from the connector 850 may be entirely supplied to the flow portion 4231 without being moved to the inlet portion 4233. The connector 850 may prevent hot air from being concentrated at one side of the flow portion 4231, thereby evenly supplying hot air into the drum. Therefore, there is an effect of increasing the drying efficiency of the laundry.

The connector 850 may be formed to increase in width toward an upstream side, so that a speed of hot air moving along the connector 850 may decrease along a flow direction. That is, the connector 850 may perform a function of a diffuser that adjusts the speed of hot air. The connector 850 may reduce the speed of hot air, thereby preventing hot air from being intensively supplied to only a specific portion of the drum.

Because of the shape of the connector 850 described above, the inlet portion 4233 disposed to face the connector 850 and prevented from interfering with the connector 850 may also be formed to increase in width as it is farther away from the air blowing duct 8231. Because of the shape of the inlet portion 4233, an overall shape of the rear plate duct 423 may be the same as ‘9’ when viewed from the front.

Because the drum is designed to rotate during the drying cycle, the drum may be spaced apart from the flow portion 4231 by a predetermined distance. Hot air may leak through the separation space.

Accordingly, the laundry treating apparatus may further include the sealing member 450 that prevents hot air from leaking into the separation space between the drum and the flow portion 4231. The sealing member 450 may be located along a circumference of the flow portion 4231.

The sealing member 450 may include the first sealing 451 disposed along an outer circumference of the flow portion 4231. The first sealing 451 may be disposed between the drum and the outer circumference of the flow portion 4231. In addition, the first sealing 451 may be disposed to be in contact with both the drum rear surface 220 and the rear plate 420 to more effectively prevent the leakage.

In one example, the first sealing 451 may be disposed to be in contact with a front surface of the connector 850. In addition, the first sealing 451 may be disposed to be in contact with the upper end of the connector 850. The connector 850 may form the flow channel through which hot air flows together with the flow portion 4231. Therefore, the first sealing 451 may be disposed to be in contact with the connector 850 and prevent hot air from leaking between the drum and the connector 850.

The sealing member 450 may include the second sealing 452 disposed along the inner circumference of the flow portion 4231. The second sealing 452 may be disposed between the drum and the inner circumference of the flow portion 4231. In addition, the second sealing 452 may be disposed to be in contact with both the drum rear surface 220 and the rear plate 420. The second sealing 452 may prevent hot air moving along the flow portion 4231 from leaking toward the mounting portion 425.

Because the drum 200 rotates during the operation of the laundry treating apparatus, continuous friction is applied to the sealing member 450 by the drum rear surface 220. Therefore, it is preferable that the sealing member 450 is made of a material capable of sealing a space between the drum rear surface 220 and the flow portion 4231 without deteriorating performance even with the frictional force and the frictional heat generated by the rotation.

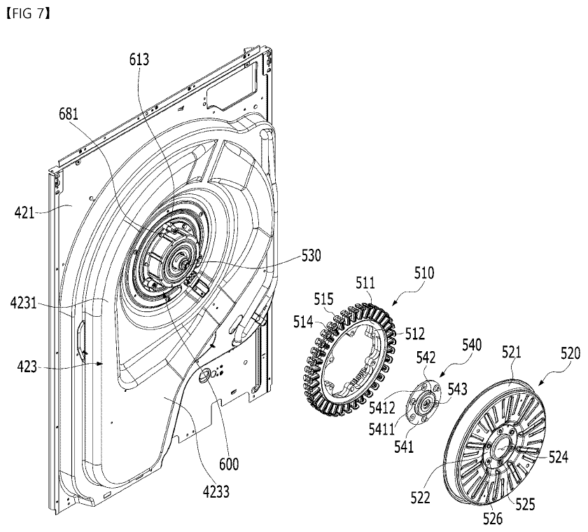

FIG. 7 illustrates a coupling structure of a rear plate, a decelerator, and a motor according to an embodiment of the present disclosure.

Referring to FIG. 7, the decelerator 600 may be supported by the rear plate 420, and the motor 500 may be coupled to the decelerator 600. That is, the rear plate 420 may support both the decelerator 600 and the motor 500.

The motor 500 that provides the rotational power and the decelerator 600 that reduces the power of the motor and transmits the reduced power to the drum may be positioned at the rear of the rear plate 420.

The decelerator 600 may be installed in the rear plate 420 so as to be positioned inside the rear plate duct 423. The decelerator 600 may be located radially inward of the flow portion 4231 so as to prevent interference with the flow portion 4231.

The gear assembly inside the decelerator 600 may be damaged by heat of hot air moving along the flow portion 4231. Accordingly, the flow portion 4231 and the decelerator 600 may be arranged to be spaced apart from each other by a predetermined distance.

The decelerator 600 may extend through and be coupled to the rear plate 420. Accordingly, the decelerator 600 may be connected to the drum positioned in front of the rear plate 420.

The stator 510 may be coupled to the decelerator 600. The stator 510 may be coupled to the decelerator 600 and installed to be spaced apart from the rear plate 420. In this regard, the decelerator 600 may be positioned between the drum and the motor and support the drum and the motor so as to be spaced apart from the rear plate 420. That is, the decelerator 600 may be a center that supports the drum and the motor.

In one example, the stator 510 may include a main body 511 formed in a ring shape, a fixing rib 512 extended from an inner circumferential surface of the main body 511 and coupled to the stator coupling portion 613 of the decelerator, a tooth 514 extending from an outer circumferential surface along a circumference of the main body 511 and allowing a coil to be wound thereon, and a pole shoe 515 disposed at a free end of the tooth 514 to prevent the coil from deviating.

The rotor 520 may include a rotor body 521 formed in a cylindrical hollow shape. In addition, the rotor 520 may include an installation body 522 recessed forward from a rear surface of the rotor body 521. In the rotor 520, a permanent magnet may be disposed along an inner circumferential surface of the rotor body 521.

The rotor 520 may be coupled to the driving shaft 530 and transmit the rotational power of the rotor 520 to the outside via the driving shaft 530. The driving shaft 530 may be connected to the rotor 520 via the washer 540.

In addition, the motor 500 may include the washer 540 supporting the driving shaft 530. The washer 540 may include the washer coupling body 541 coupled to the rotor. The washer coupling body 541 may be formed in a disk shape.

The washer 540 may include an accommodating body 542 accommodated in the rotor. The accommodating body 542 may protrude rearward from the washer coupling body 541. The washer 540 may include the shaft support hole 543 defined to extend through a center of the accommodating body 542. The driving shaft 530 may be inserted into the shaft support hole 543 and supported by the washer 540.

In addition, the washer 540 may include the washer coupling hole 5412 defined to extend through the washer coupling body 541. In addition, the installation body 522 may include a rotor coupling hole 526 defined at a location corresponding to the washer coupling hole 5412. That is, the washer 540 and the rotor 520 may be coupled to each other by a fastening member that couples the washer coupling hole 5412 with the rotor coupling hole 526 by simultaneously extending through them. That is, the washer 540 and the rotor 520 may be coupled to rotate together.

In addition, the washer 540 may include the washer coupling protrusion 5411 protruding rearward from the washer coupling body 541. In addition, the installation body 522 may include a washer protrusion accommodating hole 525 defined to correspond to the washer coupling protrusion 5411. The washer coupling protrusion 5411 may be inserted into the washer protrusion accommodating hole 525 to support the coupling between the washer portion 540 and the rotor 520.

In addition, the rotor 520 may include a rotor installation hole 524 defined through a center of the installation body 522. The rotor installation hole 524 may accommodate the accommodating body 542 therein. Accordingly, the washer 540 may rotate together with the driving shaft 530 by the rotor 520, and may firmly support the coupling between the driving shaft 530 and the rotor 520. Therefore, there is an effect of securing durability and reliability of the entire motor 500.

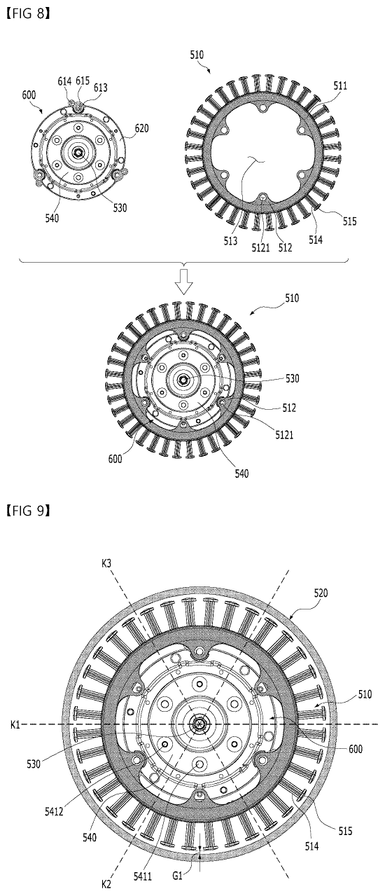

FIG. 8 is a rear view of a coupling structure of a decelerator and a stator according to an embodiment of the present disclosure.

The stator 510 may include the main body 511 fixed to the decelerator 600 and formed in the ring shape, the fixing rib 512 extending from the inner circumferential surface of the main body 511 and coupled to the stator fastening hole 615 of the decelerator, the tooth 514 extending from the outer circumferential surface along the circumference of the main body 511 and allowing the coil to be wound thereon, the pole shoe 515 disposed at the free end of the tooth 514 to prevent the coil from deviating, and a terminal (not shown) that controls a current to be supplied to the coil.

The stator 510 may include an accommodation space 513 defined inward of the main body 511 by extending through the main body 511. The fixing rib 512 may include a plurality of fixing ribs arranged on an inner side of the main body 511 to be spaced apart from each other by a predetermined angle with respect to the accommodation space 513, and a fixing rib hole 5121 in which a fixing member is installed may be defined inside each fixing rib 512, so that the fixing rib hole 5121 and the stator fastening hole 615 of the decelerator may be coupled to each other using the fixing member such as a pin.

When the stator 510 is directly coupled to the decelerator 600, a portion of the decelerator 600 may be accommodated in the stator 510. In particular, when the decelerator 600 is accommodated in the stator 510, an entire thickness of the driver including both the decelerator and the motor may be reduced, thereby further expanding a volume of the drum.

To this end, the decelerator 600 may have a diameter smaller than a diameter of the main body 511. That is, the greatest diameter of the first housing 610 and the second housing 620 may be smaller than the diameter of the main body 511. Accordingly, at least a portion of the decelerator 600 may be accommodated in and disposed in the main body 511. However, the stator coupling portion 613 may extend from the housing of the decelerator to overlap the fixing rib 512. Accordingly, the stator coupling portion 613 may be coupled to the fixing rib 512, and a portion of the first housing and the second housing 620 may be located inside the main body 511.

FIG. 9 is a diagram showing coupling of a decelerator and a motor according to an embodiment of the present disclosure.

The stator 510 may be coupled to the decelerator 600. At least a portion of the decelerator may be accommodated in the main body 511 as the fixing rib 512 is coupled to the stator coupling portion 613 protruding from the housing of the decelerator 600 to the outside. Accordingly, the center of the main body 511 and the centers of the driving shaft 530 and the decelerator 600 may always remain coaxial with each other.

In one example, the rotor 520 may be disposed to accommodate the stator 510 therein in a state of being spaced apart from the pole shoe 515 by a predetermined distance. Because the driving shaft 530 is fixed to the decelerator 600 accommodated in the main body 511, a gap G1 between the rotor 520 and the stator 510 may be maintained at all times.

Therefore, the rotor 520 may be prevented from colliding with the stator 510 and from rotating while temporarily twisting on the stator 510, thereby preventing noise or unnecessary vibration from occurring.

In one example, an imaginary first diameter line K1 passing through the center of the decelerator 600 and the center of the driving shaft 530, an imaginary second diameter line K2 passing through the center of the main body 511, and an imaginary third diameter line K3 passing through the center of the rotor 520 may all pass through the center of rotation of the decelerator 600.

Accordingly, because the decelerator 600 itself becomes a center of rotation of the driving shaft 530 and the stator 510 is directly fixed to the decelerator 600, the driving shaft 530 may be prevented from being misaligned with respect to the decelerator 600. As a result, reliability of the decelerator 600 may be guaranteed.

FIG. 10 illustrates a perspective view of the base 800 of the laundry treating apparatus according to an embodiment of the present disclosure.

The base 800 may include the circulation duct 820 that circulates air of the drum at one side thereof. In addition, the base 800 may include a device installation portion 810 disposed at a side opposite to said one side thereof to provide a space in which electric components necessary for the operation of the dryer are installed. The device installation portion 810 may be disposed outside the circulation duct 820.

In an existing dryer, the circulation duct 820 was disposed on the base 800, and the driver for rotating the drum 200 was also installed on the base 800. In this case, because the driver occupied a substantial portion of an installation space of the base 800, the device installation portion 810 had a small space, and thus it was not easy for other components of the laundry treating apparatus to be installed.

However, in the laundry treating apparatus according to an embodiment of the present disclosure, because the motor 500 that rotates the drum 200 may be disposed at the rear of the drum 200 while being spaced apart from the base 800, the space of the base 800 in which the motor 500 was previously installed may be variously utilized.

The compressor 930 that compresses the refrigerant required for the heat exchange may be installed on the device installation portion 810.

In addition, the base 800 may include a water collector 860 that is disposed to be spaced apart from the compressor 930 and collects condensate generated in the circulation duct 820 therein.

The evaporator 910 and the condenser 920 are seated inside the circulation duct 820. The evaporator 910 may cool air discharged from the drum 200 and passing through the circulation duct 820 to condense moisture contained in the air.

An amount of water condensed in the evaporator 910 may increase as an amount of moisture dried from the laundry accommodated in the drum 200 increases.

Water condensed in the evaporator 910 may be collected on a bottom surface of the circulation duct 820.

The condenser 920 generates hot air by heating air passing through the circulation duct 820. In this case, when water is collected on the bottom surface of the circulation duct 820, there is a possibility that the water may be vaporized by heat generated from the condenser 920 and may be introduced into the drum 200 again.

Therefore, the base 800 may further include the water collector 860 capable of collecting moisture condensed in the circulation duct 820 from the outside of the circulation duct 820.

The water collector 860 may be in communication with the bottom surface of the circulation duct 820 and may be disposed in the device installation portion 810 outside the circulation duct 820. The water collector 860 may collect not only water condensed by the evaporator 910 but also all water introduced into the circulation duct 820.

The water collector 860 may define a space for collecting and temporarily storing the water.

The laundry treating apparatus of the present disclosure may further include a drainage pump 861 capable of discharging water collected in the water collector 860 to the outside of the water collector 860.

The drainage pump 861 may be seated in the water collector 860 and generate power for discharging water collected in the water collector 860 to the outside of the water collector 860.

The drainage pump 861 may discharge water collected in the water collector 860 to the water storage tank 120. Accordingly, even when the water collector 860 is full, the water collector 860 may be emptied and continuously collect new condensate. As a result, water remaining in the circulation duct 820 may be minimized.

In one example, a control panel 190 that controls the compressor 930, the motor, and the like may be installed on the device installation portion 810.

It is advantageous for the water collector 860 to be disposed close to the circulation duct 820 to prevent leakage.

The water collector 860 may be disposed between the compressor 930 and the circulation duct 820.

However, as illustrated, the water collector 860 may be disposed to overlap the compressor 930 in the front and rear direction. Accordingly, a volume of the water collector 860 may be further expanded to collect a larger amount of water.

When the volume of the water collector 860 is expanded as such, a frequency of disposing of condensate collected in the water collector 860 may also be reduced, and even when new water such as water is supplied to the circulation duct 820 in addition to condensate, all of water may be collected without the leakage.

In one example, the control panel 190 may be installed on the base and be firmly supported.

Accordingly, a connection line connecting the control panel 190 with the electronic components controlled by a control box may be installed on the base 800, and a length thereof may also be reduced.

The side panels forming the side surfaces of the cabinet may be coupled to side surfaces of the base 800. The side panels may include the left panel 141 and the right panel 142. The control panel 190 may be installed on the device installation portion 810, but may be installed close to one of the side panels.

The control panel 190 may include a controller that is designed to control all of the electronic components of the laundry treating apparatus and provide a command for performing any course that the laundry treating apparatus may perform.

When the control panel 190 is disposed adjacent to the side panel 141, the user may access the control panel 190 by removing only the side panel 141. Therefore, there is an effect of increasing ease of maintenance.

When the side panel 141 is removed, various components such as the compressor 930 and the control panel 190 may be easily accessed, and thus the side panel 141 may be referred to as a service panel.

The device installation portion 810 may be located at a left side of the base 800 and the control panel 190 may be accessed when one of the side panels is removed. However, the present disclosure may not be limited thereto, and when the circulation duct 820 is formed at the left side and the device installation portion 810 is formed at a right side, the control box, the compressor, or the like may be repaired and checked by removing the right panel which is not shown.

In one example, the circulation duct 820 may be formed in a duct shape that provides a space in which air flows and the heat exchanger part 900 is installed. However, the top surface of the heat exchanger part 820 may be open to facilitate installation, repair, and the like of the circulation duct 900.

The laundry treating apparatus of the present disclosure may further include the duct cover 830 coupled to the upper portion of the circulation duct 820 to prevent leakage of air introduced into the circulation duct 820 and define the flow channel through which air moves.

The duct cover 830 may be formed in a plate shape coupled to the open top surface of the circulation duct 820.

For example, a top surface and a rear surface of the inflow duct 821 and a top surface of the movement duct 822 may be open.

The duct cover 830 may form the rear surface of the inflow duct 821 while shielding the open top surface of the movement duct 822.

In one example, the inflow duct 821 may form a complete closed curve in a shape of a quadrangular duct or a ring, and the duct cover 830 may shield the top surface of the movement duct 822.

Accordingly, the duct cover 830 may prevent air introduced via the inflow duct 821 from being discharged via the open top surface of the movement duct 822. The duct cover 830 may be considered to form the top surface of the flow channel that guides air introduced via the inflow duct 821 to the outflow duct 823.

The outflow duct 823 may include the air blowing duct 8231 that discharges air to the outside of the circulation duct 820. The air blowing duct 8231 may provide a space in which the circulation flow channel fan 950 that introduces air inside the drum into the circulation duct 820 and circulates air back to the drum 200 is installed.

The circulation flow channel fan 950 may be mounted inside the air blowing duct 8231 and adjust a circulation speed of air introduced into the circulation duct 200.

When the circulation flow channel fan 950 rotates, air may be discharged via the opening defined at the upper side of the air blowing duct 8231, and air discharged from the air blowing duct 8231 may be introduced into the drum again to dry the laundry.

Various types of fans may be applied as the circulation flow channel fan 950. For example, a sirocco fan may be applied such that air may be introduced in a direction of a rotation shaft and discharged in a radial direction. However, the present disclosure may not be limited thereto, and the various fans may be used to generate the air flow depending on a design purpose.

The duct cover 830 may form a shielding cover body 8311 that is coupled to the upper portion of the circulation duct 820 to form the upper portions of the inflow duct 821 and the circulation duct 820.

Specifically, the duct cover 820 may include a communication cover body 8312 that is coupled to a front surface of the circulation duct 820 and forms the inflow duct 821, and the shielding cover body 8311 that is formed in a plate shape and is coupled to the upper side of the movement duct 822.

The shielding cover body 8311 may extend from the communication cover body 8311, and the shielding cover body 8311 may be integrally formed with the communication cover body 8312.

The communication cover body 8312 may have an inflow communication hole 8314 defined therein to allow the drum 200 and the inflow duct 821 to be in communication with each other.

When an upstream area of the circulation duct 820 is defined as the inflow duct 821, the communication cover body 8312 may be coupled to the inflow duct 821, which is the upstream area of the circulation duct 820, and guide air discharged from the drum to the inflow duct 821 via the inflow communication hole 8314.

Because the shielding cover body 8311 is able to shield the top surface of the movement duct 822, air introduced into the inflow duct 821 may be guided to the outflow duct 823 without being discharged to the outside of the circulation duct 820.

In one example, air that is discharged from the drum 200 and circulates through the circulation duct 820 includes the foreign substances such as lint removed from the laundry. The evaporator 910 is a component that comes into contact with air discharged from the drum 200 earlier than the condenser 920 and has thin plates stacked close to exchange heat with air, so that the foreign substances such as lint are easily accumulated in the evaporator 910.

In addition, the circulation duct 820 may further include a duct filter (not shown) disposed in front of the evaporator to filter the foreign substances of air that has passed through the inflow duct 821.

When the foreign substances are accumulated in the evaporator 910 or the duct filter, not only the air flow of the circulation duct 820 may be hindered, but also the foreign substances may contain moisture and lower a coefficient of performance (COP) of the heat exchanger part 900, and even the foreign substances may decay. Therefore, there is a need to periodically remove the foreign substances accumulated in the evaporator 910 or the duct filter. However, when the user or maintenance personnel manually removes the foreign substances, removal of the foreign substances in a timely manner may not be guaranteed.

To this end, the laundry treating apparatus of the present disclosure may include a circulation cleaning part 80 capable of removing the foreign substances of the evaporator 910 or the duct filter with water collected in the water collector 820.

The removal of the foreign substances inside the circulation duct 820, such as cleaning of the evaporator 910 or cleaning of the duct filter, may be defined as cleaning of the heat exchanger part 900.

The circulation cleaning part 80 may discharge water collected in the water collector 820 into the circulation duct 820 to remove the foreign substances accumulated in the evaporator 910 or the duct filter and collect water back into the water collector 820.

The circulation cleaning part 80 may include a cleaning flow channel 833 through which the water may be guided toward the evaporator 910 or the duct filter.

The cleaning flow channel 833 may be formed as a hose or the like capable of moving the water.

However, the cleaning flow channel 833 may be integrally formed with the duct cover 830 to prevent interference with the drum 200 and to facilitate installation thereof.

For example, the cleaning flow channel 833 may be disposed on a top surface of the shielding cover body 8311.

The cleaning flow channel 833 may receive water and move water toward the evaporator 910 located below the duct cover 830.

A circulation water outlet 837 vertically extending through the shielding cover body 8311 may be defined at a downstream side of the cleaning flow channel 833. Accordingly, water moving along the cleaning flow channel 833 may be discharged into the circulation duct 820 via the circulation water outlet 837.

The circulation water outlet 837 may be disposed above the evaporator 910 that dehumidifies air discharged from the drum or may be disposed upstream of or in front of the evaporator 910.

Water discharged into the circulation duct 820 by passing through the circulation water outlet 837 may fall toward the evaporator 910 and clean the evaporator 910.

When the duct filter is disposed in front of the evaporator 910, the circulation water outlet 837 may be disposed above the duct filter.

In one example, when the circulation cleaning part 80 is disposed, water collected in the water collector 860 may move to the water storage tank 120 or to the cleaning flow channel 833.

The laundry treating apparatus of the present disclosure may include a flow channel switching valve 870 capable of determining whether to discharge water collected in the water collector 860 to the water storage tank 120 or supply the water to the cleaning flow channel 833.

The flow channel switching valve 870 may be in communication with the drainage pump 861 disposed in the water collector 860, and may be in communication with both the water storage tank 120 and the cleaning flow channel 833. The flow channel switching valve 870 may be designed to selectively open and close flow channels respectively connected to the water storage tank 120 and the cleaning flow channel 833, and may selectively transmit water collected in the water collector 860. To this end, the flow channel switching valve 870 may be formed as a 3-way valve, a 4-way valve, or a valve with more ports.

The cleaning flow channel 833 may be divided into a plurality of parts along a width direction of the heat exchanger part 900. That is, the cleaning flow channel 833 may be composed of a plurality of flow channels to move water supplied from the flow channel switching valve 870 by distributing water into respective flow channels.

Accordingly, even when the amount of water collected in the water collector 860 is small, a sufficient water amount or water pressure capable of removing the foreign substances may be secured in one flow channel of the cleaning flow channel 833. As a result, water discharged from the cleaning flow channel 833 may remove the foreign substances accumulated in at least a specific area of the heat exchanger part 900.

The flow channel switching valve 870 may be controlled to supply water to only one of the plurality of cleaning flow channels 833, and may be controlled to supply water by sequentially opening the plurality of cleaning flow channels 833.

For example, the cleaning flow channel 833 may be divided into three areas along the width direction of the heat exchanger part 900. The cleaning flow channel 833 may be formed in a diffuser shape having a distal end wider than one end thereof so as to remove the foreign substances by supplying water to an entire area of the heat exchanger part 900.

As a result, the circulation water outlet 837 may have a width equal to or greater than a width of the heat exchanger part 900, and a sum of the distal end widths of the cleaning flow channels 833 may also be equal to or greater than the width of the heat exchanger part 900.

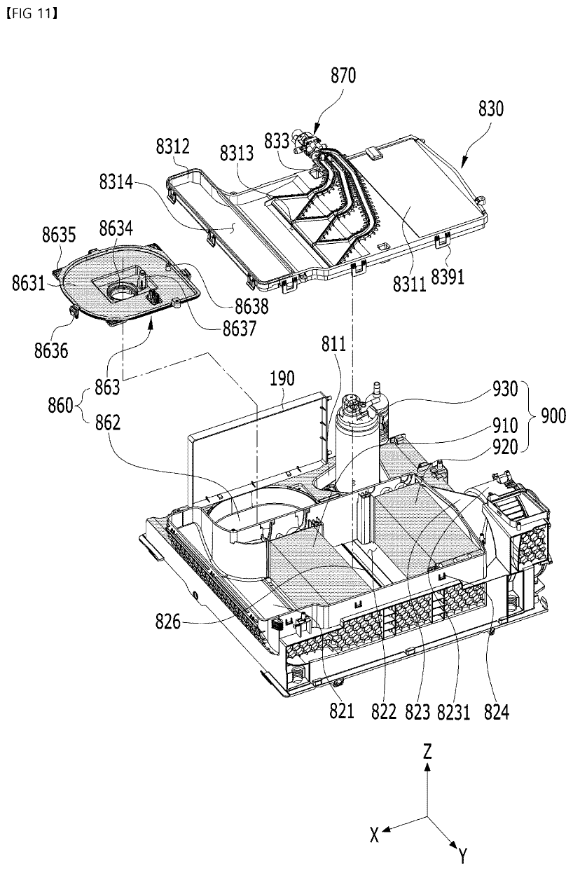

FIG. 11 is an exploded perspective view illustrating a duct cover and a water collector cover separated from a base.

The evaporator 910 and the condenser 920 may be installed inside the circulation duct 820 to be spaced apart from each other in the front and rear direction.

Air inside the drum 200 introduced into the inflow duct 821 may exchange heat in the evaporator 910 and remove moisture therefrom, and air from which moisture has been removed may be heated while exchanging heat in the condenser 920. The heated air may pass through the outflow duct 823 and be supplied back into the drum 200.

The laundry treating apparatus of the present disclosure may further include a water cover 826 disposed between the evaporator 910 and the bottom surface of the movement duct 822. The water cover 826 may be seated on the bottom surface of the movement duct 822.

The water cover 826 may be positioned under the evaporator 910 and support a bottom surface of the evaporator 910. The water cover 826 may separate the evaporator 910 from the bottom surface of the movement duct 822. Accordingly, the evaporator 910 may be prevented from being at least partially submerged in water condensed by the evaporator 910.

In one example, the water cover 826 may be spaced apart from the condenser 920. That is, the water cover 826 may be disposed upstream of the condenser 920. As a result, because condensate is not accumulated under the condenser 920, the vaporization of the condensate by the condenser 920 may be minimized.

The water collector 860 may include a water collector body 862 defining a space in which condensate is collected, and a water collector cover 863 shielding an open top surface of the water collector body 862.

The water collector cover 863 may be coupled to the water collector body 862 to prevent condensate from leaking through the top surface of the water collector body 862, and may maintain a negative pressure at which the pump 861 discharges the water.

The water collector cover 863 may include a water collector cover body 8631 forming a shielding surface of the water collector body 862. In addition, the water collector cover 863 may include at least one of a support body 8635 that supports the water collector cover body 8631 and a fastening hook 8636 that couples the water collector cover body 8631 to the water collector body 862.

The water collector cover body 8631 may extend from a pump installation portion to shield or seal a space between a circumference of the drainage pump 861 and an inner circumferential surface of the water collector body 862, and may be detachable from the base or the water collector body 862.

The support body 8635 may protrude from a circumference of the water collector cover body 8631 and be seated on the base. The fastening hook 8636 may be formed to protrude from the water collector cover body 8631. The fastening hook 8636 may firmly fix the water collector cover body 8631 to the water collector body 862. The fastening hook 8636 may be inserted into and fixed to a hook hole defined in an outer circumferential surface of the water collector body 862.

In addition, the water collector cover 863 may include a pump installation portion 8634 defined in the water collector cover body 8631 to mount the drainage pump 861 therein. The pump installation portion 8634 may be defined as a groove recessed in the water collector cover body 8631 to accommodate a portion of the drainage pump 861 therein, or may be defined as a hole extending through the water collector cover body 8631 to fix an outer circumferential surface of the drainage pump 861.

In one example, the drainage pump 861 may be connected to the flow channel switching valve 870 via a drainage flow channel 891. The drainage flow channel 891 may be formed as a single hose.

The drainage flow channel 891 may be coupled to the drainage pump 861, or may be coupled to the water collector cover 863.

For example, the water collector cover 863 may include a drain flow channel 8637 protruding upward from the water collector cover body 8631 and formed in a pipe shape allowing inside and outside of the water collector body 862 to be in communication with each other.

The pump that is designed to move condensate collected inside the water collector body 862 to the outside of the water collector body 862 may be installed in the pump installation portion 8634. When the pump is operated, condensate stored in the water collector body 862 may be discharged via the drain flow channel 8637.

The drain flow channel 8637 may be connected to the drainage hose 891, thereby guiding discharged condensate to the outside of the water collector body 862. One end of the drainage hose 891 may be coupled to the drain flow channel 8637, and the other end thereof may be connected to the flow channel switching valve 870.

The water collector cover 863 may further include a return flow channel 8638 spaced apart from the drain flow channel 8637 and allowing the inside and the outside of the water collector body 862 to be in communication with each other. The return flow channel 8638 may allow the water collector body 862 and the water storage tank to be in communication with each other. The return flow channel 8638 may guide water in the water storage tank to the water collector body 862 again when the water storage tank is full.

The drainage pump 860 may move water collected in the water collector 860 to the flow channel switching valve 870 via the drainage hose 891.

In addition, the flow channel switching valve 870 may be connected to the water storage tank 120 by a drain hose 892 and guide condensate moved from the water collector body 862 to the water storage tank 120. The user may extend the water storage tank in which condensate is stored and directly drain water.

The flow channel switching valve 870 may be controlled by the control panel 190, and may open and close different portions depending on an operating time point of the laundry treating apparatus.

For example, when the operation of the evaporator 910 is completed in the drying cycle, the control panel 190 may control the flow channel switching valve 870 to guide condensate to the cleaning flow channel 833. In addition, at a time point when the cleaning of the evaporator 910 is completely finished, the control panel 190 may control the flow channel switching valve 870 to guide condensate to the water storage tank 120.

In one example, as described above, for the drainage pump 861 to operate normally, it is preferable to seal the space in which the pump drains water. Because the water collector cover 863 may be firmly coupled to the water collector body 862 using the support body 8635 and the fastening hook 8636, the space in which condensate is stored may be easily sealed. Accordingly, an operational reliability of the drainage pump 861 may be improved. A sealing may be added to a portion where the water collector cover 863 and the water collector body 862 are coupled to each other to improve hermeticity of the space.

The water collector cover 863 may be disposed to seal the inside of the water collector body 862, but may be detachable from the water collector body 862. The foreign substances such as lint included in condensate generated by the evaporator 910 may be introduced into the water collector body 862. When foreign substances having large particles are introduced, the operation of the pump may be interfered.

Therefore, when necessary, it is necessary to detach the water collector cover 863 to remove the foreign substances introduced into the water collector body 862. Accordingly, the water collector cover 863 may be detachable from the water collector body 862. In this regard, the water collector cover 863 may be easily detached from the water collector body 862 using the fastening hook 8636.

That is, in a general use environment, the support body 8635 and the fastening hook 8636 may firmly shield the open top surface of the water collector body 862, thereby preventing condensate from being scattered to the outside.

On the other hand, when the water collector cover 863 needs to be detached to remove the foreign substances accumulated in the water collector body 862, the water collector cover may be easily detached using the fastening hook 8636.

In one example, the duct cover 830 may include a cover mounting hook 8391 formed along a periphery thereof, and the circulation duct 820 may include a duct protrusion 824 protruding along a periphery thereof to be fastened to the cover mounting hook 8391.

The cover mounting hook 8391 may be coupled to the duct protrusion 824 to couple the duct cover 830 with the circulation duct 820. That is, the duct cover 830 may be firmly fastened to the duct protrusion 824 using the cover mounting hook 8391 in a state of being seated on peripheries of the inflow duct 821 and the movement duct 822.

Sealing may be added to a contact surface between the duct cover 830 and the circulation duct 820 to prevent air from leaking from the inside of the circulation duct 820 to the outside.

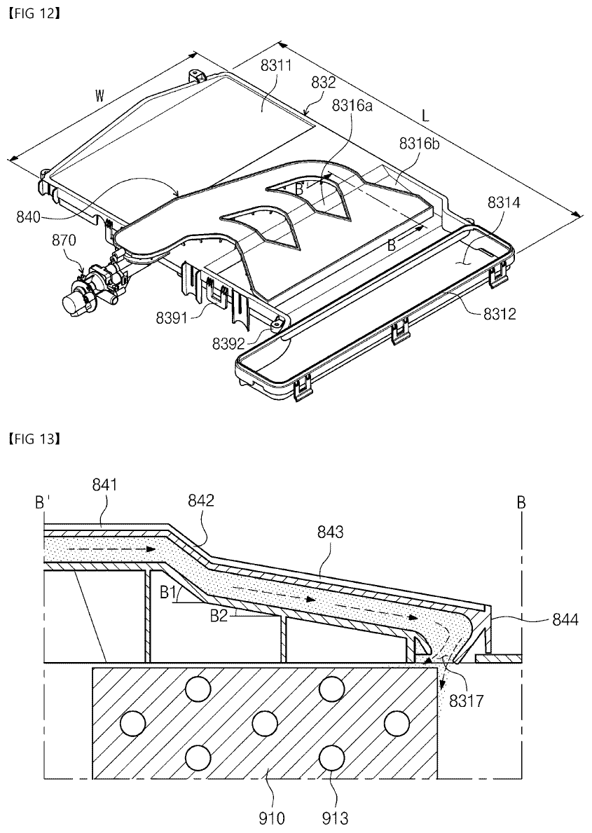

FIG. 12 is a perspective view illustrating a duct cover to which a nozzle cover is coupled in a laundry treating apparatus according to an embodiment of the present disclosure.

The cleaning flow channel 833 forms the plurality of flow channels that guide water supplied from the flow channel switching valve 870 to the water outlet 837. The cleaning flow channel 833 may be formed as a separate hose or pipe, and may be formed in a duct shape protruding from the top surface of the duct cover 830.

When the cleaning flow channel 833 is integrally formed with the duct cover 830, the cleaning flow channel 833 may be formed in a shape of a duct having an open top surface and forming a flow channel to facilitate manufacturing thereof. In this case, the circulation duct 820 may further include a nozzle cover 840 that shields the top surface of the cleaning flow channel 833 to prevent water flowing through the cleaning flow channel 833 from leaking to the outside of the cleaning flow channel 833. The nozzle cover 840 may shield an entire upper portion of the cleaning flow channel 833.

The nozzle cover 840 may prevent air moving along the movement duct 822 from leaking via the circulation water outlet 837.

The nozzle cover 840 may be coupled to an upper end of the cleaning flow channel 833 on top of the shielding cover body 8311. When the shielding cover body 8311 is viewed from above the nozzle cover 840, the nozzle cover 840 may accommodate both side surfaces of the cleaning flow channel 833 therein and shield the upper end of the cleaning flow channel 833.

The nozzle cover 840 may be formed in a shape corresponding to a shape of the cleaning flow channel 833. That is, the nozzle cover 840 may extend from a side surface of the circulation duct 820 on which the flow channel switching valve 870 is disposed to a front portion of the circulation duct 820 where the circulation water outlet 837 is disposed.

In addition, a length by which the nozzle cover 840 extends in the front and rear direction may be equal to or smaller than a total length L of the shielding cover body 8311.

A length by which the nozzle cover 833 extends in the front and rear direction may be equal to or greater than an extension length of the cleaning flow channel 833.

When the cleaning flow channel 833 is composed of a first cleaning flow channel 833a, a second cleaning flow channel 833b, and a third cleaning flow channel 833c spaced apart from each other along the width direction of the heat exchanger part 900, the nozzle cover 840 may be formed in a shape capable of shielding each of the first cleaning flow channel 833a, the second cleaning flow channel 833b, and the third cleaning flow channel 833c.

In one example, the shielding cover body 8311 may further include a first inclined surface 8316a having a first inclination such that a vertical level thereof is lowered in an area corresponding to an upper portion of the evaporator 910, and a second inclined surface 8316b having a second inclination having a smaller inclination angle than the first inclination of the first inclined surface 8315. Accordingly, water moving through the cleaning flow channel 833 may move toward the circulation water outlet 837 without additional power. In addition, even when the cleaning flow channel 833 increases in a cross-sectional area toward the circulation water outlet 837, the speed of water flowing through the cleaning flow channel 833 may not be reduced.

A width of the cleaning flow channel 833 may start to increase from the first inclined surface 8316a, and may be the greatest at the second inclined surface 8316b. Although an entire width of the circulation water outlet 837 corresponds to a width of the heat exchanger 910 and a diameter of the switching valve 870 is smaller than the width of the heat exchanger 910, water supplied from the switching valve 870 may be evenly supplied to the circulation water outlet 837.

The shielding cover body 8311 may further include, at both sides thereof, coupling hooks 8391 coupled to both side surfaces of the circulation duct 820 and fastening holes 8392 through which the fastening member coupled to the circulation duct 820 extends.

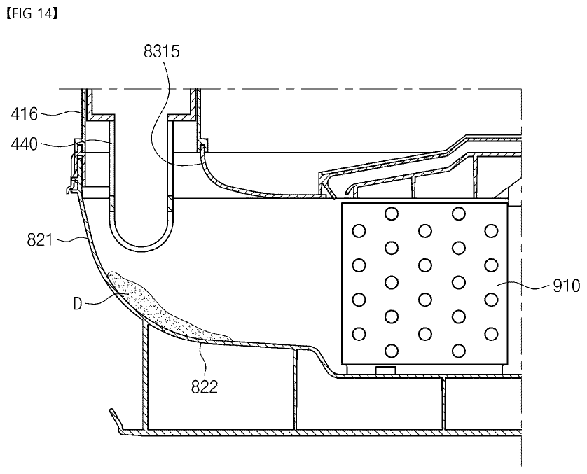

FIG. 13 is a cross-sectional view of a nozzle cover in a laundry treating apparatus according to an embodiment of the present disclosure.

The nozzle cover 840 may form the top surface of the cleaning flow channel 833.

When the inclined surface is formed in the shielding cover body, the nozzle cover 840 may also include an inclined surface corresponding thereto.

The nozzle cover 840 may include a first surface 841 disposed parallel to the shielding cover body 8311, a second surface 842 extending from the first surface and extending at a first inclination corresponding to the first inclined surface 8315, a third surface 843 extending from the second surface at a second inclination corresponding to the second inclined surface 8316, and a distal end surface 844 extending from the third surface 843 to the top surface of the shielding cover body 8311 again to shield the circulation water outlet 837 and form a flow channel distal end of the cleaning flow channel 833.

Water flowing through the cleaning flow channel 833 may collide with the distal end surface 844 and move to the circulation water outlet 837.

Because the foreign substances are intensively accumulated in a front portion of the heat exchanger part 900, the circulation water outlet 837 is defined above the front portion of the heat exchanger part 900 and induces water discharged from the drainage pump 861 to be supplied to the front portion of the heat exchanger part 900.

However, because the water has a moving inertial force by a pressure of the water discharged from the drainage pump 861 and the inclination formed at the cleaning flow channel 833, the water may be discharged further forward of the heat exchanger part 900 when passing through the circulation water outlet 837.

In this case, water discharged from the circulation water outlet 837 may not come into contact with the heat exchanger part 900 or may not be supplied to a lower portion of the heat exchanger part 900, and thus a front surface of the heat exchanger part 900 may not be entirely cleaned.

Therefore, the nozzle cover 840 may further include a switching member 846 capable of changing a moving direction of water flowing in the cleaning flow channel 833.

The switching member 846 may collide with water discharged from the cleaning flow channel 833 and induce the water to directly fall to the circulation water outlet 837.

The switching member 846 may extend from inward of the distal end surface 844 so as to be at least partially inserted into the circulation water outlet 837. In addition, the switching member 846 may extend from an inner surface of the distal end surface 844 to be inclined downward toward the heat exchanger part 900.

As a result, water collided with the switching member 846 may be discharged while moving toward the heat exchanger part 900 based on the inclination of the switching member 846. Accordingly, the front surface of the heat exchanger part 900 may be entirely cleaned from an upper portion to a lower portion.

The cleaning of the heat exchanger part 900 may include the cleaning of the evaporator 910, and may include the cleaning of the duct filter disposed upstream of the evaporator 910.

Because the circulation cleaning part 80 cleans the heat exchanger part 900 with water collected by the water collector 860, it may be considered that the circulation cleaning part 80 includes one or more of the drainage pump 861, the switching valve 870, the cleaning flow channel 833, and the circulation water outlet 837.

The circulation cleaning part 80 may discharge water moving through the drainage pump 861, the switching valve 870, the cleaning flow channel 833, and the circulation water outlet 837 into the circulation duct 820 and clean the heat exchanger part 900. In addition, water that has cleaned the heat exchanger part 900 may be collected again to the water collector 860, and may be discharged again into the circulation duct 820 via the circulation cleaning part 80.

Therefore, the circulation cleaning part 80 may repeatedly perform the cleaning while circulating water collected in the water collector 860.

The controller may control the flow channel switching valve 870 to sequentially open the plurality of cleaning flow channels 833 and sequentially clean the front surface of the heat exchanger part 900.

In addition, when the cleaning is completed, the controller may control the flow channel switching valve 870 to discharge water collected in the water collector 860 to the water storage tank 120. As a result, the removed foreign substances may be prevented from remaining in the water collector 860, the heat exchanger part 900, and the circulation duct 820.

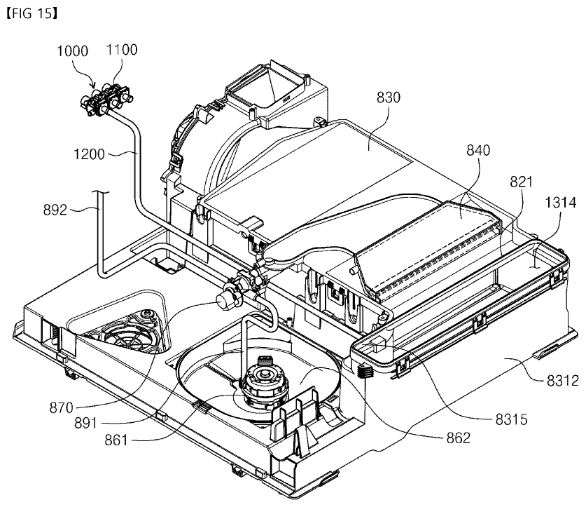

FIG. 14 illustrates a front portion or an upstream area of the circulation duct 820 of the present disclosure.

The circulation duct 820 may include the movement duct 822 in which the heat exchanger part 900 including the evaporator 910 is installed, and the inflow duct 821 that is disposed upstream of the movement duct 822 and receives air of the drum 200.

Because the drum 200 is rotatable above the movement duct 822, the inflow duct 821 may extend upward from the upstream area or the front portion of the movement duct 822 and be disposed close to the inlet of the drum 200. Accordingly, the inflow duct 821 may receive air discharged from the inlet of the drum 200.

The drum 200 may be rotatably supported by the front plate 410 disposed in front thereof.

The front plate 410 may include the duct connection portion 416 allowing the inlet of the drum 200 and the inflow duct 821 to be in communication with each other.

The duct connection portion 416 may be formed in a duct shape extending downward at a location in front of the drum 200.

The duct connection portion 416 may have an upper end facing the door or the inlet and a lower end coupled to an outer circumferential surface of the inflow duct 821.

The laundry treating apparatus of the present disclosure may include the filter 440 capable of filtering the foreign substances introduced into the inflow duct 821 from the duct connection portion 416.

The filter 440 may be inserted into the upper end of the duct connection portion 416 and may be at least partially disposed inside the duct connection portion 416.

The filter 440 may have a mesh member such as a filter net on a surface thereof, so that air may pass therethrough, but the foreign substances may be filtered.

The filter 440 may be detachable from the duct connection portion 416. When the filter 440 is mounted in the duct connection portion 416, the foreign substances discharged from the drum 200 and introduced into the circulation duct 820 may be filtered and collected. When the filter 440 is withdrawn from the duct connection portion 416, the foreign substances filtered into the filter 440 by the user may be removed.

As a mesh size of the mesh member of the filter 440 becomes smaller, a filtration performance increases, but an air resistance also increases accordingly, so that a drying efficiency may deteriorate.

Accordingly, the mesh size of the mesh member in the filter 400 may be an appropriate size that does not significantly increase the air resistance while filtering the foreign substances.

As a result, it may be difficult for the filter 440 to filter 100% of the foreign substances such as lint discharged from the inside of the drum 200.

In addition, the filter 440 may have an open upper end, but a remaining portion of an outer circumferential surface thereof may be entirely shielded. Foreign substances remaining without being introduced into the filter 440 may be disposed around the upper end of the filter 440 or around an upper end of the duct connection portion 416 in which the filter 440 is seated. In this process, when the filter 440 is withdrawn from the duct connection portion 416, the foreign substances placed around the upper end of the filter 440 or the upper end of the duct connection portion 416 may be introduced into the duct connection portion 416.

As a result, even when the filter 440 is mounted in the duct connection portion 416, a predetermined amount of foreign substances may be introduced into the inflow duct 821.

In addition, the inflow duct 821 and the movement duct 822 may have different flow channel directions. For example, the flow channel defined inside the inflow duct 821 may be directed in a downward direction, and the flow channel defined inside the movement duct 822 may be directed in a rearward direction.

A movement direction of air supplied from the duct connection portion 416 and introduced from the inflow duct 821 may be switched in a front area of the bottom surface of the circulation duct 820 where the inflow duct 821 and the movement duct 822 meet.

Because a vortex or the like occurs in the front are of the bottom surface of the circulation duct 820, the flow rate or the like may be lowered and the air resistance may increase, so that some foreign substances D may not move toward the evaporator 910 and may be accumulated.

As time elapses, the foreign substances may gradually become accumulated and increase in volume.

In the circulation duct 820, an accumulation area corresponding to the front portion of the movement duct 822 and the lower portion of the inflow duct 821 is an area disposed upstream of the evaporator 910, and corresponds to an area to which water supplied from the circulation cleaning part 80 is difficult to be delivered. Therefore, there may be a problem in that the accumulation area may not be cleaned via the circulation cleaning part 80.

In addition, when the foreign substances are accumulated in the accumulation area or a bent portion of the circulation duct 820, sufficient air is not circulated through the circulation duct 820, so that not only a drying performance of the laundry treating apparatus may be deteriorated, but also the foreign substances may be decayed and contaminate the laundry accommodated in the drum 200. Although only the accumulation area is mentioned, there may be another accumulation area in which the foreign substances are accumulated, regardless of the heat exchanger part 900, inside the circulation duct 820. The accumulation area needs to be independently cleaned regardless of the cleaning of the heat exchanger part 900.

Therefore, the laundry treating apparatus of the present disclosure may further include a water cleaning part 1000 capable of cleaning the circulation duct 820 to remove the foreign substances accumulated in the accumulation area.

The laundry treating apparatus of the present disclosure may further include the water cleaning part 1000 that cleans an area different from that of the circulation cleaning part 80.

An area in which water is discharged into the circulation duct from the water cleaning part 1000 and an area in which water is discharged into the circulation duct from the circulation cleaning part 80 may be set differently.

For example, one of the water cleaning part 1000 and the circulation cleaning part 80 may be designed to clean the evaporator 910 and an area adjacent to the evaporator 910, and the other may be designed to clean the circulation duct 820 and an area spaced apart from the evaporator 910.

For example, the circulation duct 820 is an area in which a user's body is difficult to be inserted, and it is difficult to easily remove the foreign substances once the foreign substances are accumulated, so that the water cleaning part 1000 may be designed to clean the heat exchanger part 820 other than the circulation duct 900.

Hereinafter, an embodiment of the laundry treating apparatus of the present disclosure in which the circulation cleaning part 80 cleans the exchanger assembly 900 and the water cleaning part 1000 cleans the circulation duct 820 will be described.

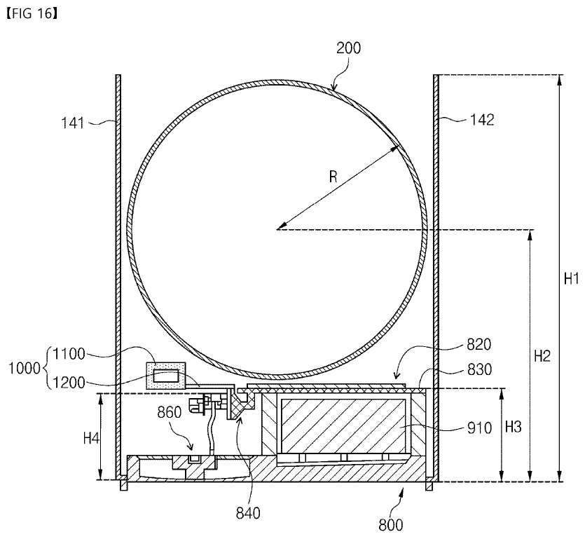

FIG. 15 illustrates an embodiment in which a laundry treating apparatus of the present disclosure cleans a circulation duct.

The laundry treating apparatus of the present disclosure may include a water cleaning part 1000 that receives water from an external water source and supplies water into the circulation duct to wash the heat exchanger part 900.

The external water source may be any component that is disposed outside the cabinet 100 and supplies water into the cabinet 100, and may correspond to, for example, a faucet disposed outside the cabinet 100.

Because the water cleaning part 1000 receives clean water without the foreign substances such as the lint discharged from the drum 200, the circulation duct 820 may always be cleaned with clean water.

Water that has been supplied from the water cleaning part 1000 and cleaned the circulation duct 820 may be discharged from the circulation duct 820 and collected in the water collector 860. Water collected in the water collector 860 may be discharged to the water storage tank 120 and discarded by the circulation cleaning part 80, and may be transmitted to the heat exchanger part 900 and clean the heat exchanger part 900.

Water that has cleaned the circulation duct 820 via the water cleaning part 1000, has been discharged to the water storage tank 820, and then has additionally cleaned the circulation duct 820 via the water cleaning part 1000 may be cleaner than water condensed in the heat exchanger 900 and collected.

Accordingly, when water that has been supplied from the water cleaning part 1000 and has cleaned the circulation duct 820 is collected again in the water collector 860 and cleans the heat exchanger part 900 via the circulation cleaning part 80, a cleaning efficiency may be higher than that of a case in which the heat exchanger part 900 is cleaned via the circulation cleaning part 80 from the beginning.

In other words, when the water cleaning part 1000 and the circulation cleaning part 80 are equipped at the same time, the circulation cleaning part 80 may clean the heat exchanger part 900 with cleaner water than when the water cleaning part 1000 is not equipped.

In one example, the laundry treating apparatus of the present disclosure may include only one of the water cleaning part 1000 and the circulation cleaning part 80, or may include only the water cleaning part 1000.

Hereinafter, a description will be made based on the fact that the laundry treating apparatus of the present disclosure includes the water cleaning part 1000 and the circulation cleaning part 80 at the same time.

Because the circulation cleaning part 80 uses water collected by the water collector 860, there is a high possibility of cleaning the heat exchanger part 900 with water containing the foreign substances such as lint and bacteria.

Therefore, the water cleaning part 1000 may be disposed independently of the circulation cleaning part 80. The water cleaning part 1000 may be disposed to be separated from or spaced apart from the water collector 860 in terms of a flow channel.

The water cleaning part 1000 may not use water collected in the water collector 860, and may be blocked from being in contact with or exposed to water collected in the water collector 860.

The water cleaning part 1000 may clean the circulation duct 820 only with water supplied from the external water source. The water cleaning part 1000 may be blocked from coming into contact with or mixing with water and the foreign substances moving along the circulation cleaning part 80.

The water cleaning part 1000 and the circulation cleaning part 80 may have locations where they start to receive water independently of each other. In addition, the water cleaning part 1000 and the circulation cleaning part 80 may also have locations where they discharge water independently of each other.

For example, the water cleaning part 1000 may receive water only from the external water source, and the circulation cleaning part 80 may receive water only from the water collector 860.

Water supplied from the water cleaning part 1000 may be collected in the water collector 860. However, water collected in the water collector 860 may be supplied only to the circulation cleaning part 80 and may not be supplied back to the water cleaning part 1000.

The circulation cleaning part 80 may include the drainage pump 861, the switching valve 870, the cleaning flow channel 833, and the circulation water outlet 837, and may further include the water collector 860 as a water supply source.

The water cleaning part 1000 may be equipped independently of all components of the circulation cleaning part 80. The water cleaning part 1000 may include a water outlet that receives water from the external water source and discharges water into the circulation duct 820. The water outlet may be equipped independently of the circulation water outlet 837.

The water cleaning part 1000 may not share the flow channel with the circulation cleaning part 80 from a start of the flow channel to an end of the flow channel. As a result, water moving from the external water source to the water outlet may be prevented from being contaminated by water flowing through the circulation cleaning part 80.

The water cleaning part 1000 may be disposed upward of the circulation cleaning part 80.

For example, the water cleaning part 1000 may include a water valve 1100 that receives water from the external water source, a water pipe 1200 that is coupled to the water valve 1100 and transmits the water, and a duct water outlet 1530 that discharges water supplied from the water pipe 1200 into the circulation duct 820.

The duct water outlet 1530 may correspond to a water outlet through which water is discharged from the water cleaning part 1000.

The water valve 1100 may be coupled and fixed to a rear surface of the cabinet. In addition, at least a portion of the water valve 1100 may be disposed inside the cabinet 100.

The duct water outlet 1530 may be disposed at a distal end of the water pipe 1200. The water pipe 1200 may extend from the water valve 1100 to the inside of the circulation duct 820 and directly supply water to the inside of the circulation duct 820.

However, the water cleaning part 1000 may further include a duct nozzle 1500 coupled to the distal end of the water pipe 1200 and having the duct water outlet 1530 that cleans the inside of the circulation duct 820.

There is a lower possibility that the foreign substances are accumulated in a portion at the rear of the heat exchanger part 900. Accordingly, the water cleaning part 1000 may be designed to supply water to an area of the circulation duct 820 disposed upstream of or in front of the heat exchanger part 900.

For example, the circulation cleaning part 80 may be designed to discharge water into the movement duct 822 to clean the heat exchanger part 900 with water collected in the water collector 860. The water cleaning part 1000 may clean the area upstream of the heat exchanger part 900, and the circulation cleaning part 80 may intensively clean the heat exchanger part 900.

The water cleaning part 1000 may be designed to directly supply water to the accumulation area such as the front portion or the bent portion of the movement duct 822.

In addition, the water cleaning part 1000 may supply water into the inflow duct 821, so that the water may be transmitted to all of the front portion, the bent portion, and the like of the movement duct 822. Accordingly, the water cleaning part 1000 may not only clean an inner surface of the inflow duct 821 with water discharged into the inflow duct 821, but also clean the bent portion where the inflow duct 821 and the movement duct 822 meet, the front portion of the movement duct 822, and the area in front of the heat exchanger part 900.

The water cleaning part 1000 may clean the accumulation area and the bottom and both side surfaces of the movement duct 822 with a strong force with water falling from the inflow duct 821.

The water cleaning part 1000 may include the water valve 1100 that is seated on the rear surface of the cabinet or at a location at the rear of the base 800 and receives water from the external water source, the water pipe 1200 extending from the water valve to the inflow duct, and the duct nozzle 1500 that is coupled to the inflow duct and discharges water supplied from the water pipe into the inflow duct 820.

The water pipe 1200 may extend parallel to the extension direction of the circulation duct 820, and may be disposed on one side of the circulation duct 820. Because the water pipe 1200 is not disposed above the circulation duct 820, it may be blocked from interfering with the rotation of the drum 200.

The water valve 1100 may be disposed downward of the drum 200, and the water pipe 1200 and the duct nozzle 1500 may also be disposed downward of the drum 200.

Water supplied from the duct nozzle 1500 may be collected in the water collector 860 after cleaning the inflow duct 821 and the movement duct 822.

The water cleaning part 1000 may operate prior to the circulation cleaning part 80. Accordingly, after all of the circulation duct 820 and the like are cleaned and cleaner water is collected in the water collector 860, the circulation cleaning part 80 may clean the heat exchanger part 900.

As a result, the drainage pump 861 may start to be operated only after the water valve 1100 is opened first and the water collector 860 is filled to the full water level.

The duct nozzle 1500 may be disposed along the inner surface of the inflow duct 821.

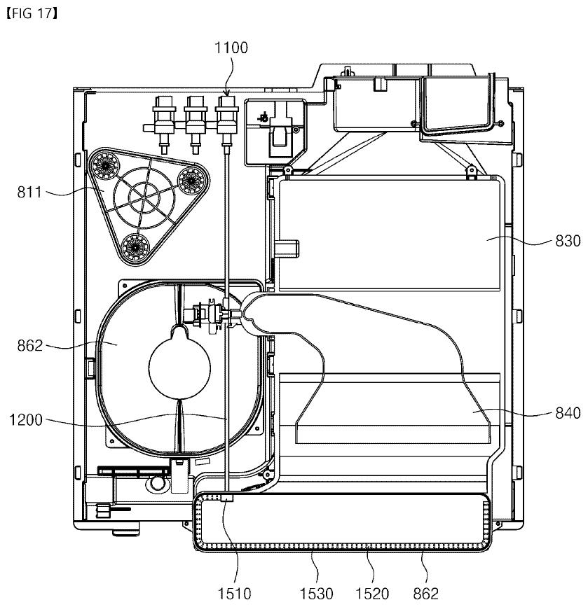

FIG. 16 illustrates a location at which a water cleaning part may be disposed.

The heat exchanger part 900 is positioned inside the circulation duct 820, and the circulation duct 820 is disposed below the drum 200.

Accordingly, the duct nozzle 1500 is seated on a portion of the circulation duct 820 located above the heat exchanger part 900.

In addition, because the evaporator 910 of the heat exchanger part 900 is located in the upstream portion of the circulation duct 820, it is disposed closer to the front portion of the circulation duct 820.

In such a state, when the water valve 1000 is disposed upward of the drum 200 as in a general washing machine or the like, and when the water pipe 1200 connects the water valve 1100 with the duct nozzle 1500 at the shortest distance, the water pipe 1200 is inevitably interfered with the drum 200, so that the water pipe 1200 may be damaged or the rotation of the drum 200 may be blocked.

Accordingly, the water pipe 1200 connecting the water valve 1000 with the duct nozzle 1500 needs to extend from an upper portion of the rear surface of the drum 200 to a lower portion of the rear surface of the drum 200, and needs to change a direction and further extend from the rear surface of the drum 200 toward the front surface of the drum 200.

In this case, because the water pipe 1200 is lengthened, the water pipe 1200 may have a great amount of water remaining, or it may be difficult for water to be supplied at a sufficient pressure when a water pressure is low.

In addition, when the water pipe 1200 is formed as a hose or the like having an elastic force, it is not only difficult to fix the water pipe 1200, but also there is a high possibility of interference with the drum 200.

For example, when a total height of the cabinet 100 is referred to as a first height H1 and a height to a center of rotation of the drum 200 is referred to as a second height H2, the laundry treating apparatus of the present disclosure may arrange the entire components of the water cleaning part 1000 below a vertical level corresponding to the second height H2.

Accordingly, the water valve 1100 may be disposed closer to the circulation duct 820 to reduce an extension length of the water pipe 1200.

The laundry treating apparatus of the present disclosure may arrange the entire components of the water cleaning part 1000 below the drum 200.

The water valve 1100 may be disposed outside the drum 200 at a location lower than the center of rotation of the drum, and as a result, an entirety of the water valve 1100 may be disposed below the drum 200 with no portion thereof facing the rear surface of the drum 200.

Therefore, interference of the water pipe 1200 with the drum 200, the driver 500, or the like may be prevented.

In addition, the water valve 1100 and the water pipe 1200 may be disposed to be spaced apart from the base 800. As a result, the water valve 1100 and the water pipe 1200 may be prevented from being damaged or separated from each other by vibration or the like.

In addition, the duct nozzle 1500 may be disposed upward of the circulation duct 820.

In one example, the water valve 1100 may be disposed at or above a vertical level corresponding to a third height H3, which is a height of the circulation duct 820. As a result, a vertical level difference between the water valve 1100 and the water nozzle 1300 occurs, so that a pressure of water supplied to the duct nozzle 1500 may become higher than a water pressure of the external water source. Accordingly, even when the water pressure of the external water source is low, the pressure of water discharged from the duct nozzle 1500 may increase to an extent that the foreign substances may be removed.

The water pipe 1200 may be disposed above the vertical level corresponding to the third height H3, but at least a portion thereof may be disposed on one side surface of the circulation duct 820 above the device installation portion 810 and may be disposed below the vertical level corresponding to the third height H3.

As a result, the interference of the water pipe 1200 with the drum 200 may be further prevented.

The water pipe 1200 may be disposed upward of the flow channel switching valve 870, but may extend from below the flow channel switching valve 870. As a result, even when the vibration is transmitted to the base 800, the water pipe 1200 may be prevented from instantaneously coming into contact with the drum 200.

In summary, the water valve 1100 may be disposed downward of the drum 200 and upward of the heat exchanger part 900 or the circulation duct 820.

The duct nozzle 1500 may be disposed at a location lower than the drum 200 and higher than the heat exchanger part 900 or the circulation duct 820.

The water pipe 1200 may extend from the water valve 1100 to the duct nozzle 1500 at a location lower than the drum 200 and higher than the bottom surface of the circulation duct 820.

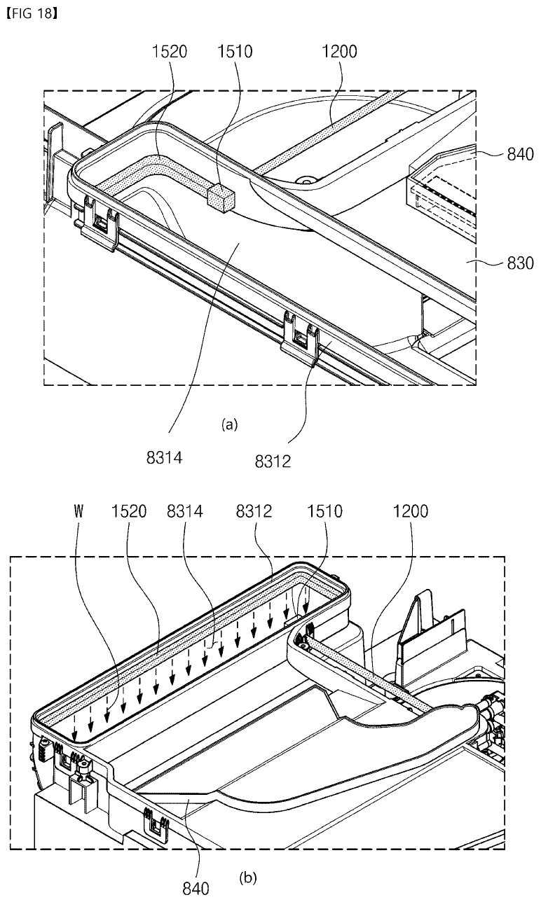

FIG. 17 illustrates a structure of the water cleaning part.

The duct nozzle 1500 may include a guide pipe 1510 that is coupled to the inflow duct and guides water supplied from the water pipe into the inflow duct, a guide duct 1520 that is in communication with the guide pipe 1510, extends along the inner surface of the inflow duct, and guides water, and the duct water outlet 1530 that passes through the guide duct 1520 and sprays water into the inflow duct.

Accordingly, even when the water pipe 1200 is disposed rearward of the inflow duct 821, water may be supplied along the inner surface of the inflow duct 821 because of the duct nozzle 1500.

The duct nozzle 1530 may be designed to supply water to only a portion of the inner surface of the inflow duct 821, not to an entirety thereof.

Specifically, based on the opening of the inflow duct 821, the front surface and both side surfaces of the inflow duct 821 extend from an upper portion to a lower portion of the inflow duct 821, but the rear surface of the inflow duct 821 is disposed to be completely spaced apart from the movement duct 821.

Accordingly, the duct nozzle 1500 may supply water to at least one of the front surface and both side surfaces of the inflow duct 821 except for the rear surface of the inflow duct 821.

The guide duct 1520 may be disposed to extend from the guide pipe 1510 to both side surfaces and the front surface of the inflow duct 821, and may be omitted from being disposed on the rear surface of the inflow duct 821.

Accordingly, at least a portion of water discharged from the duct water outlet 1530 may fall along the inner surface of the inflow duct 821 and be guided to the movement duct 822.

The water pipe 1200 may extend from a location downward of the switching valve 870 and be connected to the guide pipe 1510. Accordingly, interference of the water pipe 1200 with the drum 200 may be fundamentally blocked.

In one example, the guide duct 1520 may be disposed at a location accommodating at least a portion of the filter 440 therein. Accordingly, an outer surface of the filter 440 may also be cleaned, and foreign substances disposed outside the filter 440 and expected to fall may be cleaned in advance.

FIG. 18 illustrates a detailed structure of the duct nozzle.

Referring to (a) in FIG. 18, the guide pipe 1510 may be disposed on a rear surface of an area protruding from the inflow duct 821 toward the water collector 860 and be in communication with the water pipe 1200.

The guide pipe 1510 may receive water from the water pipe 1200 and store a predetermined amount of water therein.

The guide duct 1520 may extend from the guide pipe 1510 along the inner surface of the inflow duct 821. The guide duct 1520 may include a flow channel defined therein through which water supplied from the guide pipe 1510 moves.

The guide duct 1520 may be formed in a duct shape with an inside thereof shielded except for the duct water outlet 1530. Accordingly, even when high-pressure water is introduced into the guide duct 1520, water may be prevented from leaking arbitrarily.

Referring to (b) in FIG. 18, the duct water outlet 1530 may discharge water supplied from the external water source toward the inner surface or the lower portion of the inflow duct 821 from the guide duct 1520.

Water discharged from the duct water outlet 1530 may fall as it is to clean the accumulation area, or may move while sweeping down the inner surface of the inflow duct 821 from a location where the guide duct 1520 is disposed to the lower portion.

Accordingly, the duct nozzle 1500 may clean the inner surface of the inflow duct 821 first and then clean the portion of the movement duct 822 in front of the heat exchanger part 900.

In addition, the duct water outlet 1530 may not directly discharge water toward the filter 440. Accordingly, the outer surface of the filter 440 is not wet with water, thereby avoiding interference with the movement of air.

As a result, water discharged from the duct water outlet 1530 may completely sweep off foreign substances attached to the outer surface of the filter 440 to fall, foreign substances separated at the filter 440, and foreign substances falling into the duct connection portion 416.

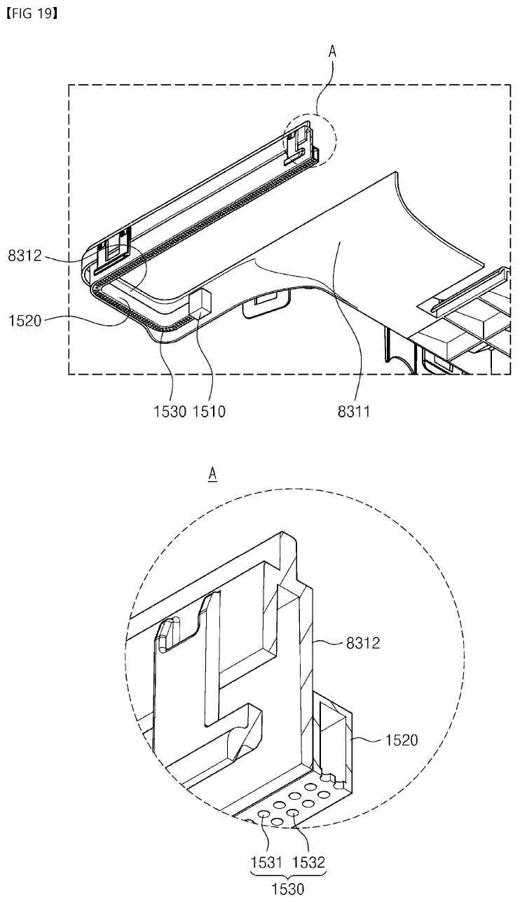

FIG. 19 illustrates a structure of a duct water outlet.

The duct water outlet 1530 may vertically discharge water toward the movement duct. The duct water outlet 1530 may obliquely discharge water toward the inner wall of the inflow duct 821.

However, the duct water outlet 1530 may not obliquely discharge water toward the filter 440.

That is, the duct water outlet 1530 may vertically extend through a bottom surface of the guide duct 1520 or obliquely extend therethrough toward the inner surface of the inflow duct 821.

The guide duct 1520 may block the inside thereof from being exposed except for the duct water outlet 1530 so as to temporarily store therein water introduced from the guide pipe 1510.

A total cross-sectional area of the duct water outlet 1530 may be set to be smaller than a cross-sectional area of the guide pipe 1510.

The duct water outlet 1530 may include a first water outlet 1531 extending through a lower portion of the guide duct along at least a portion of the inner surface of the inflow duct 821, and a second water outlet 1532 extending through the lower portion of the guide duct at a location inward of the first water outlet 1531 within the inflow duct.

The first water outlet 1531 may discharge water toward the inner surface of the inflow duct, and the second water outlet 1532 may discharge water toward the movement duct.

The predetermined amount of water may be stored in the guide duct 1520 and discharged to the duct water outlet 1530.

Therefore, even when the water pressure or the water amount of the external water source is insufficient, as water is collected first in the guide duct 1520, a cleaning water amount may be secured, and a cleaning force may be secured because of a vertical level difference.

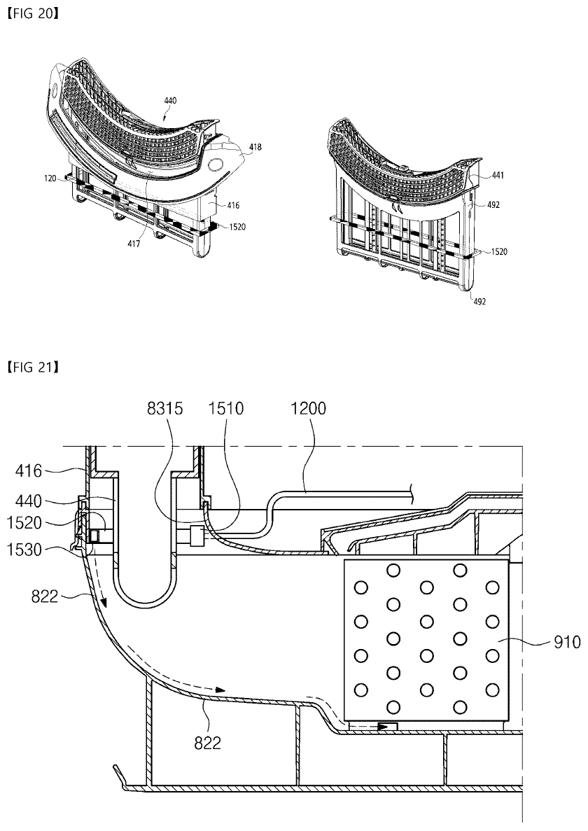

FIG. 20 illustrates a locational relationship between a filter and a water cleaning part.

Referring to (a) in FIG. 20, the duct nozzle 1500 may supply water to an area of the inflow duct 821 disposed between an upper end and a lower end of the filter 440.

The duct nozzle 1530 may be disposed to overlap the filter 440, thereby securing the cleaning force for cleaning the inside of the circulation duct 820 such as the inflow duct 821.

A filter mounting portion 418 where the filter 440 is seated and having a duct communication hole 417 through which air in the drum is introduced defined therein may be disposed on top of the duct connection portion 416.

The duct communication hole 417 may extend through an upper end of the duct connection portion 416, and the filter mounting portion 418 may extend from an outer circumferential surface of the duct communication hole 417 to have an area size greater than an area size of the duct connection portion.

The filter mounting portion 418 may be disposed under a door introduction hole defined in the front casing.

The duct nozzle 1500 may be disposed downward of the filter mounting portion 418. In addition, the duct nozzle 1500 may supply water to a location downward of the duct connection portion 416.

To this end, the guide duct 1520 may be disposed along at least a portion of a periphery of the filter 440 disposed downward of the duct connection portion 416.

Accordingly, the filter 440 may be cleaned starting from the area thereof exposed downwardly of the duct connection portion 416, and the outer surface of the filter 440 may be prevented from being unnecessarily wetted and interfering with the flow of air.

Referring to (b) in FIG. 20, the filter 440 may include an external filter 492 that is inserted into the duct connection portion 416 and filters the foreign substances, and an internal filter 441 that is inserted into the external filter 492 and filters the foreign substances.

At least a portion of the external filter 492 may be inserted into the internal filter 441, and the remaining portion thereof may be seated on the internal filter 441.

The duct nozzle 1500 may be disposed in an area where the internal filter 441 and the external filter 492 overlap each other. Accordingly, the filter 440 may be intensively cleaned starting from an area where the foreign substances may leak to the outside.

The guide duct 1520 may be disposed between the lower end and the upper end of the filter 440 and discharge water supplied from the external water source.

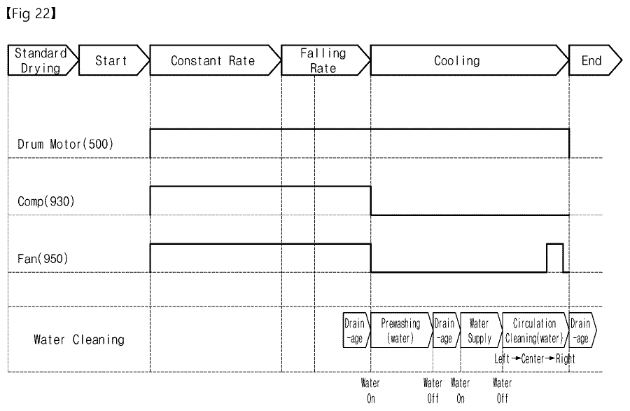

FIG. 21 illustrates a derived effect of a duct nozzle.

Water supplied from the water pipe 1200 may be introduced into the guide pipe 1510 and move to a periphery of the introduction duct 821 along the guide duct 1520.

In this process, water may be discharged through the duct water outlet 1530 and sequentially clean the inflow duct 821 and the movement duct 822 to remove foreign substances D.

The foreign substances D may be transferred to the lower portion of the heat exchanger part 900, discharged to the water collector 860, and removed from the circulation duct 820.

The foreign substances collected in the water collector 860 may be discarded into the water storage tank 120 or discharged to the outside of the cabinet to be completely removed.

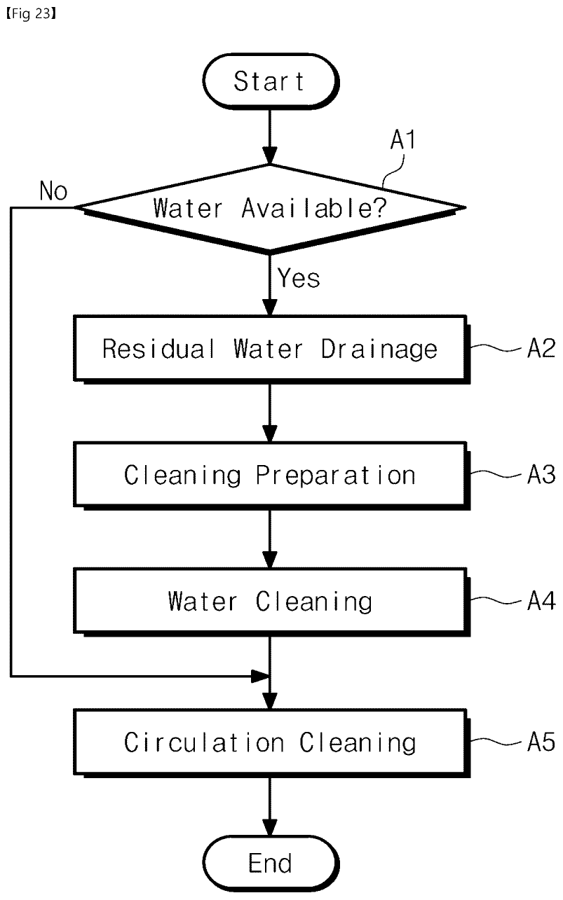

FIG. 22 illustrates a control method in which a laundry treating apparatus of the present disclosure performs a drying course.

Referring to FIG. 22, when the laundry treating apparatus performs the arbitrary drying course of drying moisture of the laundry, it goes through a heating step, a constant rate step, a falling rate step, and a cooling step based on a temperature of the laundry or a temperature inside the drum.

The heating step is a step in which the compressor 930 and the circulation flow channel fan motor 951 are operated to supply hot air into the drum 200. In this regard, the drum 200 may be rotated by the driver.

In the heating step, the temperature inside the drum 200 may increase.

In the heating step, when hot air having a sufficient temperature is supplied into the drum 200, an amount of moisture dried from the laundry increases.

The constant rate step in which the moisture absorbs energy of the hot air as heat of vaporization and thus the temperature inside the drum 200 is almost maintained or the temperature increase is slowed is followed.

When moisture of the laundry is sufficiently dried as the constant rate step progresses, an amount of moisture vaporized from the laundry is also reduced and thus the heat of vaporization absorbed from the hot air is also reduced.

Therefore, the drying course enters the falling rate step in which the temperature inside the drum 200 is increased by hot air supplied to the drum 200.

In the falling rate step, the drying of the drum may be completed as the temperature inside the laundry 200 gradually increases.

When the drying of the laundry is completed, the operation of the compressor 930 may be stopped.

In addition, when the drying of the laundry is completed, the cooling step of lowering the temperature inside the drum 200 is performed.

In the cooling step, the drum 200 may continue to rotate, and the circulation flow channel fan 950 may be in operation or stop operating.

As a result, when the falling rate step is completed, the drying of the laundry may be considered to be completed.

The laundry treating apparatus of the present disclosure may automatically clean the heat exchanger part 900 during the drying course. As a result, the heat exchanger part 900 may be cleaned even when the user does not separately input a command for cleaning the heat exchanger part 900.

FIG. 23 illustrates a control method in which a laundry treating apparatus of the present disclosure controls a water cleaning part and a circulation cleaning part.

Hereinafter, a description will be made on the basis that the control method is applied while the drying course is in progress.

However, when the laundry treating apparatus of the present disclosure includes a cleaning course of independently cleaning the heat exchanger part 900 or the circulation duct 820, the control method may be equally applied when a command for performing the cleaning course is input.

When the laundry treating apparatus of the present disclosure cleans the heat exchanger part 900 or the circulation duct 820, a residual water drainage step A2 of storing water collected in the water collector 860 in the water storage tank 120 may be performed.

For example, the residual water drainage step A2 may be performed when the falling rate step is completed and the operation of the compressor 930 is completed during the drying cycle.

The residual water drainage step A2 may include operating the drainage pump 861 while the switching valve 870 opens only the drain pipe 892. Accordingly, in the residual water drainage step A2, all of water collected in the water collector 860 may be discharged to the water storage tank 120 without leaking into the circulation duct 820.

In the residual water drainage step A2, the drainage pump 861 may be in operation until all of water collected in the water collector 860 is discharged to the water storage tank 120 as much as possible.

Accordingly, water condensed in the evaporator 910 during the drying cycle process may be collected in the water storage tank 120 and may not be utilized for cleaning the heat exchanger part 900 or the circulation duct 820. As a result, the heat exchanger part 900 may be prevented from being re-contaminated by the foreign substances generated in the drying cycle.

When water of the water collector 860 is drained in the residual water drainage step A2, a water cleaning step A4 of immediately cleaning the circulation duct 820 with the water cleaning part 1000 may be performed.

However, when the foreign substances remain in the water collector 860 and the circulation duct 820, there is a concern that the foreign substances may be re-supplied to the heat exchanger part 900.

Accordingly, the laundry treating apparatus of the present disclosure may perform a cleaning preparation step A3 or pre-washing of preparing to clean the circulation duct 820 with the water cleaning part 1000, before immediately cleaning the circulation duct 820 with the water cleaning part 1000.

The laundry treating apparatus of the present disclosure may open the water valve 1100 and simultaneously operate the drainage pump 861 in the cleaning preparation step A3. In the cleaning preparation step A3, the switching valve 870 may be in a state of opening the drain pipe 892.

As a result, in the cleaning preparation step A3, water supplied from the water pipe 1200 may clean the circulation duct 820 and simultaneously clean the water collector 860, and then be collected in the water storage tank 120.

As a result, the foreign substances remaining in the circulation cleaning part 80 may be more reliably removed.

Thereafter, the cleaning preparation step A3 may be performed during a preparation time period t3. The preparation time period t3 may be a time period during which an amount of water corresponding to a preparation amount is collected in the water storage tank 120. For example, the preparation amount may correspond to an amount corresponding to a full water level of the water collector 862.

In addition, the preparation time period t3 may be a time period for ensuring that the foreign substances in the circulation cleaning part 80 are cleaned with water. For example, the preparation time period t3 may correspond to about 3 minutes.

When the cleaning preparation step A3 is ended, the water cleaning step of opening the water valve 1100 and stopping the operation of the drainage pump 861 may be performed

The cleaning preparation step A3 may be ended after closing the water valve 1100 and draining all of water collected in the water collector 860, before the water cleaning step A4 is performed.

That is, it may be seen that the cleaning preparation step A3 is finished by discharging water collected in the water collector 860.

When water in the water collector 860 is collected in the water storage tank 120 or discharged to the drain hole, the water cleaning step A4 of cleaning the circulation duct 820 with water supplied from the external water source may be performed.

The water cleaning step A4 may be a step of opening the water valve 1100.

In the water cleaning step A4, the drainage pump 861 may not be operated. Accordingly, supply of excess water from the water valve 1100 to the circulation duct 820 and the water collector 860 may be prevented.

In the water cleaning step A4, the water valve 1100 may be closed when the water level of the water collector 860 reaches a reference water level.

The reference water level may correspond to a water level capable of ensuring that the circulation duct 820 has been sufficiently cleaned with water supplied from the water valve 1100.

For example, the reference water level may correspond to the full water level of the water collector 860.

In the water cleaning step A4, the laundry treating apparatus of the present disclosure may remain the water valve 1100 opened until the water level of the water collector 860 reaches a reference water level H, and directly clean the circulation duct 820 with the water via the duct nozzle 1500.

When the water collector 860 reaches the reference water level in the water cleaning step A4, the drainage pump 861 may be operated.

When the drainage pump 861 is in operation, the switching valve 870 may open the drain pipe 892. In this case, the drainage pump 861 may discharge all of water collected in the water collector 860 to the water storage tank 120 or the outside of the cabinet. In this case, the laundry treating apparatus of the present disclosure may repeat the water cleaning step A4.

Specifically, the water valve 1100 may remain opened until the water level of the water collector 860 reaches the reference water level H while the operation of the drainage pump 861 is stopped.

The water cleaning step A4 may be repeated a reference number of times. Accordingly, the heat exchanger part 900 may be cleaned a reference number of times with clean water supplied from the external water source.

The water cleaning step A4 may be ended in the state in which water is stored in the water collector 860 in an amount corresponding to the reference water level H.

That is, the water cleaning step A4 may be ended in the state in which the drainage pump 861 is stopped from being operated after the water valve 1100 is opened.

Thereafter, the laundry treating apparatus of the present disclosure may perform a circulation cleaning step A5 of cleaning the heat exchanger part 900 with water collected in the water collector 860.

Accordingly, the laundry treating apparatus of the present disclosure may clean the heat exchanger part 900 by circulating water without the foreign substances or having a low content of the foreign substances, supplied from the external water source. In addition, the laundry treating apparatus of the present disclosure may clean the heat exchanger part 900 while circulating water several times in the circulation cleaning step A5, thereby saving water and simultaneously maximizing circulation cleaning efficiency.

The circulation cleaning step A5 may include operating the drainage pump 861 in a state in which the switching valve 870 closes the drain pipe 892 and opens the cleaning flow channel 833.

The circulation cleaning step A5 may be the same as an existing residual water cleaning method when there is no water supply.

Because the circulation cleaning step A5 is to clean the heat exchanger part 900 via the cleaning flow channel 833, when the cleaning flow channel 833 is partitioned into the plurality of parts, the switching valve 870 may sequentially open the plurality of cleaning flow channels 833.

For example, when the circulation cleaning step A5 is performed, the switching valve 870 may open only one of the plurality of cleaning flow channels and operate the drainage pump 861.

The drainage pump 861 may be in operation until all of water collected in the water collector 860 is discharged, and may temporarily stop operating when all of water collected in the water collector 860 is discharged.

The switching valve 870 may sequentially open the plurality of cleaning flow channels 833 while the drainage pump 861 is in operation. Accordingly, all of the plurality of cleaning flow channels 833 may be cleaned with water collected in the water collector 860.

Alternatively, the switching valve 870 may open selected few or only one of the plurality of cleaning flow channels 833 until the drainage pump 861 is operated once and then stopped, and may open another cleaning flow channel when the drainage pump 861 is operated again. Accordingly, the selected few or only one of the cleaning flow channels may be intensively cleaned using all of water collected in the water collector 860, and another cleaning flow channel may be intensively cleaned again using all of water collected in the water collector 860. This process may be repeated until all of water collected in the water collector 860 passes through all of the cleaning flow channels 833.

As a result, the circulation duct 820 may be cleaned first with water to effectively remove the foreign substances, and the remaining foreign substances may be additionally removed from the heat exchanger part 900 by the circulation cleaning with water.

The water is a concept to be distinguished from condensate, and is able to be defined as water supplied from the external water source.

In addition, the circulation duct 820 and the water collector 860 may be repeatedly washed with water. As a result, all of the foreign substances may be removed from the base.

The circulation cleaning step A5 may be ended by discharging all of water collected in the water collector 860 to the water storage tank 120 or the outside of the cabinet.

That is, when the heat exchanger part 900 is cleaned via all the cleaning flow channels 833 in the circulation cleaning step A5, the switching valve 870 may open the drain pipe 892 and close all the cleaning flow channels 833. Thereafter, the drainage pump 861 may discharge all of water collected in the water collector 860 to the water storage tank 120 or the drain hole.

It is merely an embodiment that the residual water drainage step A2, the cleaning preparation step A3, the water cleaning step A4, and the circulation cleaning step A5 are sequentially performed, and the laundry treating apparatus of the present disclosure may immediately perform the water cleaning step A4 after the operation of the compressor is ended, or may immediately perform the circulation cleaning step A5.

In addition, only the residual water drainage step A2 and the water cleaning step A4 may be performed and the circulation cleaning step A5 may be omitted after the operation of the compressor is ended.

However, when performing both the water cleaning step A4 and the circulation cleaning step A5, the laundry treating apparatus of the present disclosure may perform the water cleaning step A4 before the circulation cleaning step A5. Accordingly, the circulation cleaning step A5 may be performed using water supplied from the external water source, not the condensate.

The residual water drainage step A2, the cleaning preparation step A3, the water cleaning step A4, and the circulation cleaning step A5 described above may be performed on the premise that water is supplied from the external water source. The process may not be performed in a state in which the external water source and the water cleaning part 1000 are not connected to each other.

To this end, the laundry treating apparatus of the present disclosure may further perform a sensing step A1 of sensing whether water is supplied from the external water source to the water valve 1100.

The sensing step A1 may be performed after the operation of the compressor 930 is ended in the drying course. In addition, the sensing step A1 may be performed when the laundry treating apparatus of the present disclosure is turned on or may be performed while the compressor 930 is in operation.

The sensing step A1 may be performed at any time point as long as it is performed before the residual water drainage step A2 is performed.

The sensing step A1 may be performed by mechanically sensing whether the water valve 1100 is connected to the external water source.

In addition, a flow rate sensor that senses water passing through the water valve 1100 or senses water passing through the water pipe 1200 or the like may be disposed.

The laundry treating apparatus of the present disclosure may perform the sensing step A1 using the water cleaning part 1000 and the circulation cleaning part 80 even when the separate sensing device is not equipped.

When it is sensed in the sensing step A1 that the water valve 1100 is able to receive water from the external water source, one or more of the residual water drainage step A2, the cleaning preparation step A3, the water cleaning step A4, and the circulation cleaning step A5 described above may be performed.

However, when it is sensed in the sensing step A1 that the water valve 1100 is in a state of not being able to receive water from the external water source, the laundry treating apparatus of the present disclosure may immediately perform the circulation cleaning step A5.

In the state of not being able to receive water from the external water source, the laundry treating apparatus of the present disclosure may immediately perform the circulation cleaning step A5 to use water condensed in the evaporator 910 for cleaning the heat exchanger part 900 without discarding the water into the water storage tank 120 or the drain hole.

Even when the water cleaning part 1000 is in the state of receiving water from the external water source, a method of performing the water cleaning step A4 needs to be changed in the laundry treating apparatus of the present disclosure when receiving water at a pressure or a flow rate higher than normal (hereinafter, referred to as a high water pressure state) or at a pressure or a flow rate lower than normal (hereinafter, referred to as a low water pressure state).

Therefore, in the sensing step A1, it is necessary to sense whether water supplied from the external water source to the water valve 1100 is in the normal state, the low water pressure state, or the high water pressure state.

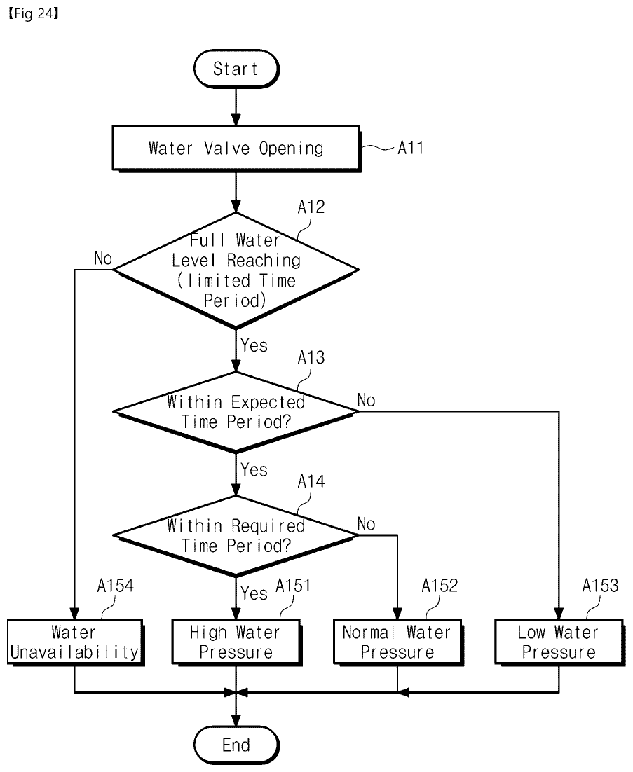

FIG. 24 illustrates an embodiment in which a laundry treating apparatus of the present disclosure performs the sensing step using a water cleaning part and a circulation cleaning part.

When the sensing step A1 is performed, the laundry treating apparatus of the present disclosure may perform an opening step A11 of opening the water valve 1100.

When the opening step A11 is performed, an unavailability sensing step A12 of sensing whether the water collector 860 has reached the reference water level or the full water level within a limited time period may be performed.

The laundry treating apparatus of the present disclosure may sense the water level via the water level sensor coupled to the water collector 860. In addition, the laundry treating apparatus of the present disclosure may intermittently operate the drainage pump 861 and sense the water level via the pump load even without the water level sensor.

When the water level of the water collector 860 does not reach the reference water level or the full water level in the unavailability sensing step A12, the laundry treating apparatus of the present disclosure may perform an unavailability confirmation step A154 of determining that the water valve 1100 does not receive water enough to perform the cleaning from the external water source.

When the unavailability confirmation step A154 is performed, the laundry treating apparatus of the present disclosure may clean the heat exchanger part 900 using only the circulation cleaning step A5.

The limited time period may be set to a time period not causing a drying delay or an excessive electricity. The limited time period may correspond to 5 minutes.

The reference water level may be set based on an amount of water capable of sufficiently cleaning the heat exchanger part 900 with water collected in the water collector 860. For example, it may correspond to a water level higher than half the vertical dimension of the water collector 860.

When the opening step A11 is performed, the laundry treating apparatus of the present disclosure may perform an availability determination step A13 of sensing whether the water level of the water collector 860 has reached the reference water level or the full water level within an expected time period.

The availability determination step A13 may be a step of determining whether the water cleaning step A4 is available.

The expected time period may be set to a time period sufficient for water to be filled in the water collector 860 to the reference water level as long as the pressure and the amount of water of the external water source are abundant.

Accordingly, the expected time period may be set to be smaller than the limited time period. For example, the expected time period may correspond to 2 minutes.

When the water level of the water collector 860 does not reach the reference water level or the full water level within the expected time period in the availability determination step A13, the laundry treating apparatus of the present disclosure may perform a low water pressure confirmation step A153 of determining that the external water source is in the low water pressure state of having the low water pressure or the low water amount for performing the water cleaning step A4.

When the opening step A11 is performed, the laundry treating apparatus of the present disclosure may perform a rapid determination step A14 of sensing whether the water level of the water collector 860 has reached the reference water level or the full water level within a required time period.

The required time period may be set to a minimum time period during which an amount of water sufficient to clean the circulation duct 820 is supplied to clean the circulation duct 820.

In other words, the required time period may be a minimum time period required to clean the circulation duct 820.

Therefore, the required time period may be set to be smaller than the expected time period. For example, the required time period may correspond to 1 minute.

In the rapid determination step A14, when the water level of the water collector 860 reaches the reference water level or the full water level within the expected time period, but the water level of the water collector 860 does not reach the reference water level or the full water level within the required time period, the laundry treating apparatus of the present disclosure may perform a normal confirmation step A152 of determining that the external water source is able to supply an appropriate amount of water.

However, in the rapid determination step A14, when the water level of the water collector 860 reaches the reference water level or the full water level within the expected time period, and the water level of the water collector 860 reaches the reference water level or the full water level within the required time period, the laundry treating apparatus of the present disclosure may perform a high pressure confirmation step A151 of determining that the external water source supplies an excessive amount of water to perform the water cleaning step A4.

The laundry treating apparatus of the present disclosure may not perform the water cleaning step A4 or may perform the water cleaning step A4 differently depending on whether the external water source is coupled to the water valve 1100 and the amount and the pressure of water supplied from the external water source.

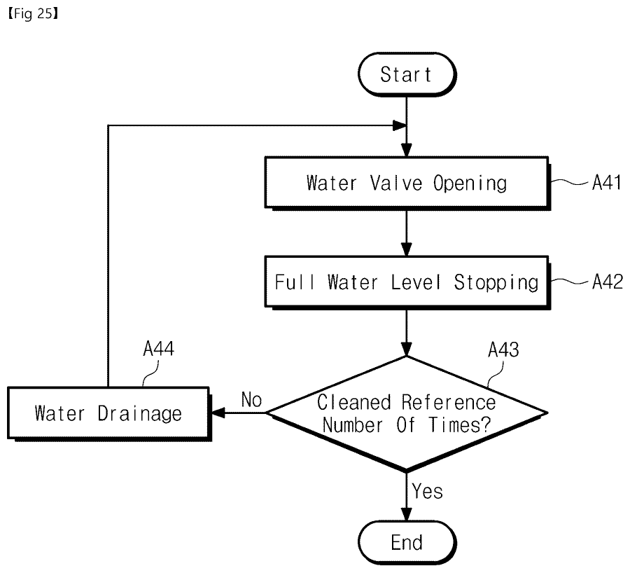

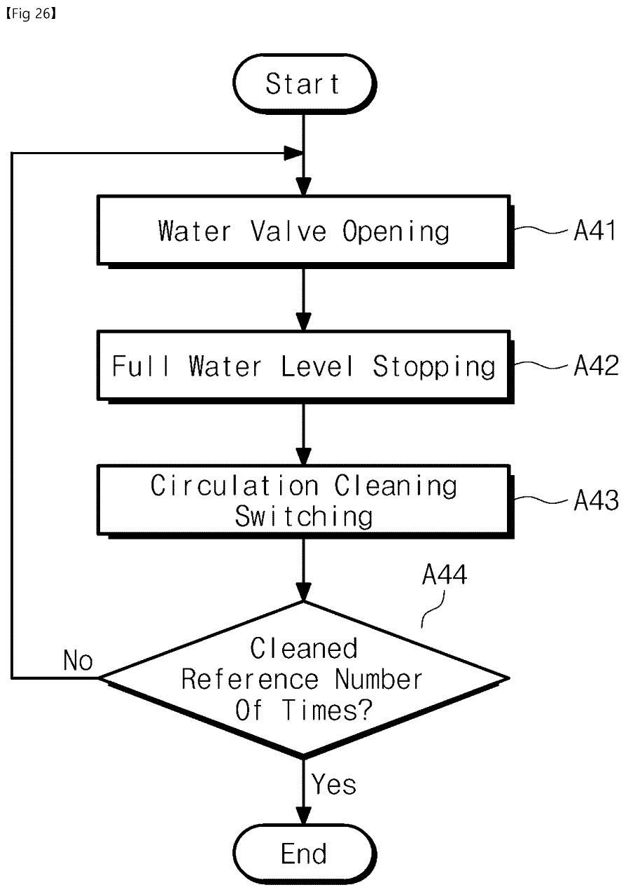

FIG. 25 illustrates a method of performing a water cleaning step when a water pressure of an external water source is in a normal state or a high water pressure state.

When the water cleaning step A4 is performed, the laundry treating apparatus of the present disclosure may perform an opening step A41 of opening the water valve 1100.

The opening step A41 includes opening the water valve 1100 and guiding water of the external water source to the water pipe 1200 and the water nozzle 1300. In the opening step A41, the drainage pump 861 may stop operating.

The opening step A41 is a step of directly cleaning the heat exchanger part 900 with water. Water that has cleaned the heat exchanger part 900 may be collected in the water collector 860 as it is.

Water that has cleaned the heat exchanger part 900 and the foreign substances collected from the heat exchanger part 900 and the circulation duct 820 may remain in the water collector 860.

When the water level of the water collector 860 reaches the reference water level or the full water level, a stopping step A42 of closing the water valve 1100 may be performed.

When the stopping step A42 is performed, the laundry treating apparatus of the present disclosure may perform a number times determination step A43 of determining whether the heat exchanger part 900 has been cleaned with the water for a reference number of times.

The reference number of times corresponds to the number of times ensuring that the foreign substances may be sufficiently removed with the water supply when the foreign substances are attached to the heat exchanger part 900.

When the cleaning is not performed for the reference number of times in the number of times determination step A43, the laundry treating apparatus of the present disclosure may perform a water drainage step A44 of discharging water collected in the water collector 620.

The water drainage step A43 may include operating the drainage pump 861 in a state in which the switching valve 870 opens only the drain pipe 892 and closes the cleaning flow channel 833.

As a result, the laundry treating apparatus of the present disclosure may perform the opening step A41 and the stopping step A42 again, and additionally clean the heat exchanger part 900.

When the opening step A41 and the stopping step A42 are performed the reference number of times, the laundry treating apparatus of the present disclosure may omit the water drainage step A44 and end the water cleaning step A4.

As a result, water supplied from the external water source that has cleaned the heat exchanger part 900 may be eventually stored in the water collector 860. The water may have a low content of foreign substances, and may be in a state almost the same as the state of water supplied from the external water source. Accordingly, the laundry treating apparatus of the present disclosure may clean the heat exchanger part 900 with clean water collected in the water collector 860 via the circulation cleaning step A5.

Because of the opening step A41 and the stopping step A42, the water cleaning step A4 is stopped when water is supplied beyond the reference water level or the full water level of the water collector 860.

Because the water collector 860 reaches the reference water level or the full water level more quickly when the external water source is in the high water pressure state than in the normal state, a cleaning time period of the heat exchanger part 900 is reduced.

Therefore, when the external water source is in the high water pressure state, high-pressure water may be delivered to the heat exchanger part 900, but the required time period may not be secured, so that the heat exchanger part 900 may be less cleaned than when the external water source is in the normal state.

Therefore, the laundry treating apparatus of the present disclosure may increase the reference number of times in the high water pressure state compared to the normal state. In other words, in the high water pressure state, the heat exchanger part 900 may be cleaned more times than in the normal state.

For example, the reference number of times in the normal state may correspond to one or two times, and the reference number of times in the high water pressure state may correspond to three or more times.

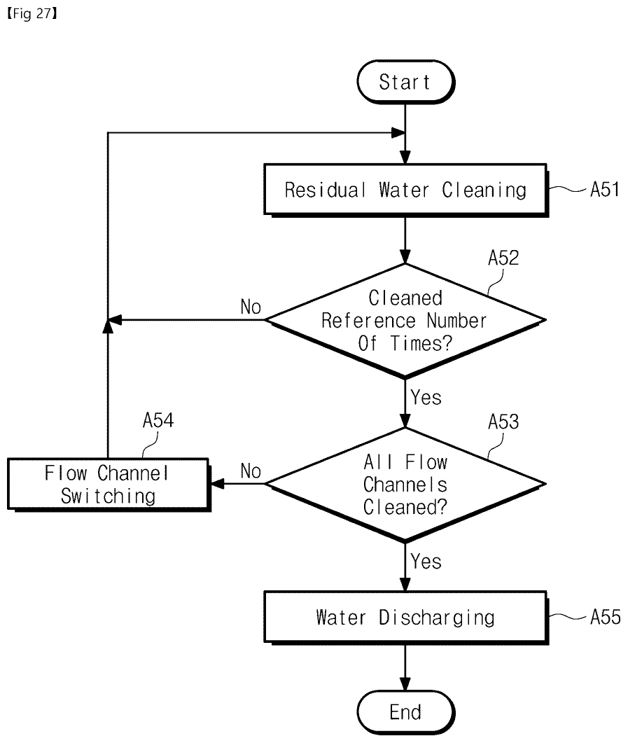

FIG. 26 illustrates a method of performing a water cleaning step when a water pressure of an external water source is in a low water pressure state.

When the water cleaning step A4 is performed, the laundry treating apparatus of the present disclosure may perform an opening step a41 of opening the water valve 1100. The opening step a41 in the low water pressure state may be the same as the opening step A41 in the normal state.

In addition, when the water level of the water collector 860 reaches the reference water level or the full water level, a stopping step a42 of closing the water valve 1100 may be performed.

In the low water pressure state, the stopping step a42 may be the same as the stopping step A42 in the normal state.

However, when the external water source is in the low water pressure state, even when the water valve 1100 is opened for a long time period, the water pressure required to clean the heat exchanger part 900 may not be secured.

Accordingly, when the stopping step a42 is performed, the laundry treating apparatus of the present disclosure may perform a circulation cleaning switching step a43 of cleaning the heat exchanger part 900 via the circulation cleaning part 80.

The circulation cleaning switching step a43 may be the same as the circulation cleaning step A5.

Accordingly, the heat exchanger part 900 may be cleaned with water collected in the water collector 860 at the pressure provided by the drainage pump 861.

Because the water cleaning step A4 is performed after the residual water drainage step A2 after the drying cycle, the circulation cleaning switching step a43 may clean the heat exchanger part 900 with water cleaner than that in the circulation cleaning step A5 with the water cleaning step A4 omitted.

Accordingly, the laundry treating apparatus of the present disclosure may clean the heat exchanger part 900 using the power of the drainage pump 861 even when water of the sufficient pressure is not supplied from the external water source.

The laundry treating apparatus of the present disclosure may perform a number of times determination step a44 of determining whether the heat exchanger part 900 has been cleaned for a reference number of times in the circulation cleaning switching step a43.

The reference number of times corresponds to a number of times ensuring that the foreign substances may be sufficiently removed via the drainage pump 861 when the foreign substances are attached to the heat exchanger part 900.

When the cleaning is not performed for the reference number of times in the number of times determination step a43, the laundry treating apparatus of the present disclosure may discharge water collected in the water collector 620 and perform the opening step a41 and the stopping step a42 again.

In addition, when the cleaning is not performed for the reference number of times in the number of times determination step a43, the laundry treating apparatus of the present disclosure may sequentially open the cleaning flow channels 833 again via the switching valve 870 and operate the drainage pump 861 to clean the heat exchanger part 900.

When the water cleaning step A4 is performed in the low water pressure state, the circulation cleaning step A5 may be omitted.

When the cleaning is performed for the reference number of times in the number of times determination step a43, a drainage step of draining all of water in the water collector 860 to the water storage tank 120 or the drain hole may be performed.

FIG. 27 illustrates a method for controlling a laundry treating apparatus of the present disclosure when water supply is unavailable.

The laundry treating apparatus of the present disclosure may immediately perform the circulation cleaning step A5 when the water supply is unavailable in the sensing step A41.

The circulation cleaning step A5 may include a residual water cleaning step A51 of cleaning the heat exchanger part 900 with condensate collected in the drying cycle.

The residual water cleaning step A51 may include operating the drainage pump 861 in a state in which the switching valve 840 opens one of the plurality of cleaning flow channels.

The laundry treating apparatus of the present disclosure may perform a cleaning determination step A52 of determining whether the specific cleaning flow channel has been cleaned a reference number of times.

In the cleaning determination step A52, when the specific flow channel has been cleaned less than the reference number of times, the laundry treating apparatus of the present disclosure may repeatedly supply condensate to the cleaning flow channel.

When the specific flow channel has been cleaned the reference number of times in the cleaning determination step A52, the laundry treating apparatus of the present disclosure may perform a completion determination step A53 of determining whether all the flow channels have been cleaned.

When condensate has been supplied to all of the cleaning flow channels in the completion determination step A53, a removal step A55 of discharging condensate collected in the water collector 860 to the water storage tank 820 or the drain hole may be performed.

After the removal step A55, the laundry treating apparatus may be turned off.

On the other hand, when not all of the flow channels have been cleaned in the completion determination step A53, a flow channel switching step A54 of opening another cleaning flow channel with the switching valve 870 may be performed.

Thereafter, the residual water cleaning step A51 and the cleaning determination step A52 may be performed. When the specific flow channel has been cleaned by the reference number of times in the cleaning determination step A52, the laundry treating apparatus of the present disclosure may perform the completion determination step A53 of determining whether all the flow channels have been cleaned.

Although the present disclosure has been illustrated and described with respect to the specific embodiments, it will be apparent to those skilled in the art that the present disclosure may be variously improved and modified without departing from the technical spirit of the present disclosure provided by the following claims.

What is claimed is:

1. A laundry treating apparatus comprising:
a cabinet;
a drum disposed inside the cabinet and having a drum inlet defined in a front portion thereof allowing laundry to be inserted thereinto;
a circulation duct configured to guide air discharged from the drum to the drum;
a fan disposed inside the circulation duct and configured to move air;
a heat exchanger part disposed inside the circulation duct and configured to cool air to condense moisture and heat air;
a water collector in communication with the circulation duct and configured to collect water condensed in the heat exchanger part or water delivered from the circulation duct therein;
a circulation cleaning part configured to clean the heat exchanger part with water collected in the water collector; and
a water cleaning part equipped independently of the circulation cleaning part, and configured to receive water from an external water source and supply water to the inside of the circulation duct to clean the inside of the circulation duct.

2. The laundry treating apparatus of claim 1, wherein the water cleaning part is configured to discharge water to an area of the circulation duct disposed upstream of heat exchanger part or in front of the heat exchanger part.

3. The laundry treating apparatus of claim 1, wherein the circulation duct includes:
an inflow duct configured to receive air from the front portion of the drum;
a movement duct extending from the inflow duct rearward to be closer to a rear portion of the drum, wherein the heat exchanger part is disposed in the movement duct; and
an outflow duct configured to discharge air from the movement duct to the rear portion of the drum,
wherein the circulation cleaning part is configured to discharge water into the movement duct,
wherein the water cleaning part is configured to discharge the water to the inflow duct.

4. The laundry treating apparatus of claim 3, wherein the water cleaning part includes:
a water valve coupled to a rear surface of the cabinet and configured to receive water from the external water source;
a water pipe extending from the water valve to the circulation duct; and
a duct nozzle coupled to the circulation duct and configured to discharge water supplied from the water pipe into the circulation duct.

5. The laundry treating apparatus of claim 4, wherein the circulation cleaning part includes:
a drainage pump mounted in the water collector and configured to discharge water from the water collector;
a drain flow channel disposed upward of the movement duct and configured to guide water discharged from the drainage pump to a front portion of the heat exchanger part;
a drain pipe connecting the drainage pump with the drain flow channel; and
a circulation water outlet extending through the movement duct at a distal end of the drain flow channel and configured to guide water to the heat exchanger part,
wherein the water pipe is disposed to be spaced apart and separated from all of the drainage pump, the drain flow channel, and the drain pipe.

6. The laundry treating apparatus of claim 5, wherein the drain flow channel and the drain pipe are shorter than the water pipe.

7. The laundry treating apparatus of claim 5, wherein the water valve is first opened and then the drainage pump is operated.

8. The laundry treating apparatus of claim 7, wherein the water valve is first opened, after the water collector is filled to a full water level, and then the drainage pump is operated.

9. The laundry treating apparatus of claim 7, further comprising a water storage tank configured to separately store water of the water collector therein,
wherein the circulation cleaning part further includes a switching valve coupled to the movement duct and configured to determine to discharge water in the water collector to one of the water storage tank and the drain flow channel,
wherein the switching valve is controlled to:
guide water collected in the water collector to the water storage tank when the water valve is first opened and then the water collector is filled to the full water level; and
guide water collected in the water collector to the drain flow channel when the water valve is opened again and the water collector is filled to the full water level again.

10. A laundry treating apparatus comprising:
a cabinet;
a drum disposed inside the cabinet and having a drum inlet defined in a front portion thereof allowing laundry to be inserted thereinto;
a circulation duct configured to guide air discharged from the drum to the drum;
a fan disposed inside the circulation duct and configured to move air;
a heat exchanger part disposed inside the circulation duct and including at least one heat exchanger configured to condense and heat air; and
a water cleaning part configured to supply water supplied from an external water source into the circulation duct,
wherein the water cleaning part is configured to discharge water to an area of the circulation duct disposed upstream of the heat exchanger or an area of the circulation duct disposed in front of the heat exchanger.

11. The laundry treating apparatus of claim 10, wherein the circulation duct includes:
an inflow duct configured to receive air from the front portion of the drum and disposed upward of the heat exchanger;
a movement duct extending from the inflow duct rearward to be closer to a rear portion of the drum, wherein the heat exchanger is disposed in the movement duct; and
an outflow duct configured to discharge air from the movement duct to the rear portion of the drum,
wherein the water cleaning part is configured to discharge water into the inflow duct.

12. The laundry treating apparatus of claim 11, further comprising a filter detachably disposed in the inflow duct and configured to filter air introduced into the inflow duct,
wherein the water cleaning part is provided to supply water to the filter, and is provided to supply water to a portion above the lower end of the filter.

13. The laundry treating apparatus of claim 11, wherein the water cleaning part includes:
a water valve coupled to a rear surface of the cabinet and configured to receive water from the external water source;
a water pipe extending from the water valve to the inflow duct; and
a duct nozzle coupled to the inflow duct and configured to discharge water supplied from the water pipe into the inflow duct.

14. The laundry treating apparatus of claim 13, wherein the duct nozzle includes:
a guide pipe coupled to the inflow duct and configured to guide water supplied from the water pipe into the inflow duct;
a guide duct in communication with the guide pipe and extending along at least a portion of an inner surface of the inflow duct to guide water; and
a duct water outlet extending through the guide duct and configured to spray water into the inflow duct.

15. The laundry treating apparatus of claim 14, wherein the duct water outlet is configured to obliquely discharge water toward the inner surface of the inflow duct.

16. The laundry treating apparatus of claim 14, wherein the duct water outlet is configured to allow water to fall from the inner surface of the inflow duct toward the movement duct.

17. The laundry treating apparatus of claim 14, wherein the duct water outlet includes:
a first water outlet extending through a lower portion of the guide duct along at least the portion of the inner surface of the inflow duct; and
a second water outlet extending through the lower portion of the guide duct, wherein the second water outlet is disposed inside the inflow duct thanthe first water outlet.

18. The laundry treating apparatus of claim 17, wherein the first water outlet is configured to discharge water toward the inner surface of the inflow duct,
wherein the second water outlet is configured to discharge water toward the movement duct.

19. The laundry treating apparatus of claim 14, further comprising a filter detachably disposed in the inflow duct and configured to filter air introduced into the inflow duct,
wherein the guide duct is configured to accommodate the filter therein.

20. The laundry treating apparatus of claim 14, wherein the guide duct is constructed such that the inside thereof is prevented from being exposed except for the duct water outlet so as to temporarily store water introduced from the guide pipe therein.

21. The laundry treating apparatus of claim 20, wherein a total cross-sectional area of the duct water outlet is set to be smaller than a cross-sectional area of the guide pipe.

22. The laundry treating apparatus of claim 13, wherein the water valve is disposed at a location lower than the drum and higher than the heat exchanger part.

23. The laundry treating apparatus of claim 22, wherein the water pipe extends to one side of the circulation duct.

24. A laundry treating apparatus comprising:
a cabinet;
a drum disposed inside the cabinet and having a drum inlet defined in a front portion thereof allowing laundry to be inserted thereinto;
a circulation duct configured to guide air discharged from the drum to the drum;
a fan disposed inside the circulation duct and configured to move air;
a heat exchanger part disposed inside the circulation duct and configured to cool air to condense moisture and heat air;
a water cleaning part configured to receive water from an external water source and clean the inside of the circulation duct;
a water collector in communication with the circulation duct and configured to collect water condensed in the heat exchanger part or delivered from the circulation duct therein; and
a circulation cleaning part configured to clean the heat exchanger part with water collected in the water collector,
wherein water is controlled to be first supplied from the water cleaning part to clean the circulation duct and then be supplied from the circulation cleaning part to clean the heat exchanger part.

25. The laundry treating apparatus of claim 24, wherein the water collector is configured to also collect water supplied from the water cleaning part.

26. The laundry treating apparatus of claim 24, wherein the circulation cleaning part is configured to clean the heat exchanger part with water supplied from the water cleaning part and collected in the water collector.
